(19) United States
(12) Patent Application Publication
(10) Pub. No.: US 2002/0107859 A1
(43) Pub. Date: Aug. 8, 2002

(54) Associating information management system, program for associating information management, and recording medium

(75) Inventor: Akemi Tsuyuki, Oita-shi (JP)

Correspondence Address: ARMSTRONG,WESTERMAN & HATTORI, LLP, 1725 K STREET, NW., SUITE 1000, WASHINGTON, DC, 20006, US

(73) Assignee: Tsuyuki Software Laboratory, Oita-shi (JP)

(21) Appl. No.: 10/043,212

(22) Filed: Jan. 14, 2002

(30) Foreign Application Priority Data
Jan. 12, 2001 (JP) 2001-005803
Nov. 9, 2001 (JP) 2001-344038

(51) Int. Cl. G06F 17/00; G06F 7/00

(52) U.S. Cl. 707/100

(57) ABSTRACT

The present invention provides an associating information management system for managing various types of information by associating. The system comprises at least a relationship management table 6 for storing association of parent-child relationship in identification information of various types of information, and retrieval processing means 4 for performing retrieval processing of various types of information from parent to child and from child to parent by association of the relationship management table in the designated information and scope. The identification information comprises ID, FAT information, address recorded in FAT, file type, directory pass, file name, scope of selection, object, attributes and information having attributes. Various types of information are managed by a member management table 7 for storing member data comprising the identification information and detailed information. As a result, it is possible to register and manage the association of various types of information by simple arrangement and to facilitate retrieval and extraction of the relationship.

### BACKGROUND OF THE INVENTION

The present invention relates to an associating information management system for the management of information by associating various types of information, and to a program for the associating information management, and also to a recording medium. The invention also relates to a pedigree type human relationship management system for recording information data of individual persons and organizations by systematizing mutual relationship.

In the present-day information-oriented era and the age of IT revolution, extensive propagation is now seen in various fields of personal computer, portable information terminal (PDA), and other types of information terminal devices. In association with such propagation, the information to be processed and managed at the information terminals is now extremely diversified including the information relating to individual person, information relating to organization, information relating to business operation, customer and other business, information relating to document and literature, and information relating to various types of management. The information is not only diversified in types but also in the amount of information. To cope with such situation, there arise diversified relationships between these types of information. To effectively utilize the relationship of various types of information, it is essential and indispensable to arrange the information and place the relationship of the information under perfect management.

In general, in making association or linking between various types of information, it is generally practiced to build up association in a tree structure from higher position to lower position according to a fixed rule. In case of a family tree, connection is made from parent to children, and further, to children of the children, and to other relatives. The association of the relationship from higher position to lower position is basically important, and the relationship is normally not entangled in complicated manner.

However, when the types and amount of the information are increased, for instance, in a certain type or category, it becomes necessary to perform association or linking of the relationship including the information of different types and different categories for the purpose of rearranging the total entity of the information. FIG. 1 shows an example of a relationship chart, and FIG. 2 represents an example of various types of information arranged by the association.

For instance, if it is supposed that various types of information A-J are associated with each other as shown by arrows in FIG. 1, the association of all types of information is not generally represented by a tree structure as shown by solid lines. The relationship between A and F may be given by an association between A and B, C and D via dotted line. In this way, there are different routes of association in many cases. The relationship is then entangled and complicated if there are many different types of information. Also, as shown in FIG. 2, if there are different units of information such as literature, ◯ ◯ university, ◯ ◯ construction firm, a person who prepares the document, drawings, ◯ ◯ document, section or department in charge of management, etc. If we take special notice of ◯ ◯ document, it is associated or related with a person who prepares the document, literature, drawings, application document, storage place, or section or department in charge.

In addition to the association of different types and categories of information associated as described above, when it is wanted to systematize human relationship or human connection in the information relating to individual person, the number of persons connected or related to one person may include several to several hundreds of persons. Further, there is a friend of a friend who is further connected to another friend. The same person may be repeatedly associated in a pedigree of the same human relationship, and the situations are very complicated.

When the association of these different types of information is expressed in a general relationship chart, it is very complicated, entangled and troublesome. It is very difficult to record all of these relationships. In this respect, it is necessary to manage the information by limiting the relationship depending on each intended purpose. For instance, in case of human relationship, only the important part of the relationship is placed under management by human memory. This is the situation we are confronted with at present.

In a general family pedigree, it is possible to indicate family members in direct line, while it is difficult to indicate the relationship of maternal relatives connected by marriage. Maternal relatives of the eldest son can be indicated somehow as shown in FIG. 3. However, when it is wanted to indicate all of the maternal relatives of all brothers, to include all maternal relatives based on the marriage of each of the brothers of all spouses and to include all other maternal relatives of parents and brothers of the parent and maternal relatives of the parent's home, there is no other approach but to express the relationship by a 3-dimensional method.

Moreover, it is a family relationship. The name of an individual given in a family tree appears only at one point. The number of brothers is a little more than a dozen at the most.

However, when human relation is to be systemized, the number of the persons connected to a single person will be several to several hundreds of persons as shown in FIG. 4. A friend of a friend may be a friend of another friend. The same person may appear repeatedly in the same pedigree.

Under such situation, it is very difficult to record the relationship, and all of these relationships cannot be recorded. For this reason, only the important part of the whole human relationship is placed under management, relying on human memory.

In the past, a system for managing the information has been proposed (JP-A-2000-66970), in which name of transmitter, name of addressees are extracted from e-mail address. Also, an apparatus for obtaining human relationship information has been proposed (JP-A-11-66082), in which the information on visiting cards is read by computer and the information that a visiting card was given from Mr. So-and-so is registered.

However, in the prior art as described above, only 2-dimensional connection of human relationship is defined, and it is not possible to define or retrieve the information regarding extensive and deep human relationship in 3-dimensional extent such as parent-child relationship (senior-junior relationship).

### SUMMARY OF THE INVENTION

It is an object of the present invention to provide a system, by which it is possible to register and manage the association of various types of information by a simple arrangement. Further, it is another object of the present invention to provide a system, by which it is possible to retrieve and extract the relationship of information in convenient manner. Further, it is still another object of the present invention to provide a system, by which it is possible to express a pedigree of human relationship on a 2-dimensional paper so that the route of relationship can be searched in reliable manner even when the same person repeatedly appears in the pedigree. Further, it is yet still another object of the present invention to provide a system, by which it is possible to express the connection by parent-child relationship, to clearly distinguish the relationship and to differentiate the deep connection. Further, it is still another object of the present invention to provide a system, by which it is possible to perform pedigree type human relationship management and to indicate a family pedigree not by generation but by degree of relatives and to freely trace and to display a family tree without fixing direction of connection in parent direction and child direction.

To attain the above object, the present invention provides an associating information management system for associating various types of information and for managing the information, said system comprising a relationship management table for storing parent-child relationship in identification information of each type of information; and retrieval processing means for performing retrieval processing of various types of information from parent to child and from child to parent by association of the relationship management table in the information and the scope as designated.

Further, the present invention provides the associating information management system as described above, wherein said various types of information are managed by a member management table where member data comprising said identification information and detailed information are stored. Said detailed information comprises type and rank, classification and job type and also comprises classification information for classifying the members. Further, the present invention provides the associating information management system as described above, wherein said detailed information comprises various types of information including FAT information, address recorded in FAT, file type, directory pass, file name, scope of selection, object, attribute and information having attribute. Also, the present invention provides the associating information management system as described above, wherein said identification information comprises ID, FAT information, address recorded in FAT, file type, directory pass, file name, scope of selection, object, attribute, or information having attribute. Further, the present invention provides the associating information management system as described above, wherein said relationship management table comprises information of mutual associating direction and degree of relationship.

Also, the present invention provides an associating information management system for managing by associating various types of information, said system comprising a relationship management table for storing parent-child relationship in identification information of each information, a member management table for storing said identification information and said various type of information, input processing means for performing input, setting and indication of the data, associating information management means for retrieving various types of information from parent to child and from child to parent by association of the relationship management table in the information and the scope as designated by said input processing means and for processing various types of information stored in the member management table, and output processing means for performing output processing of the data processed by said associating information management means. Further, the present invention provides the associating information management system as described above, wherein said input processing means associates one or a plurality of data stored in said member management table with one or a plurality of different types of data under a given condition, and stores the result of the association in said relationship management table.

Also, the present invention provides an associating information management system provided with database, said database comprising, a member management table for storing member information of individuals and organizations including name or organization name, address, telephone number, etc., and a relationship management table for defining relationship between a member registered in the member management table and another member related to said member by parent-child relationship and for entering classification code to indicate type of relationship and priority rank of the relationship.

In this database, it is preferable to provide, in addition to the relationship management table, an classification table for defining which relationship the classification code indicates and which priority rank the classification code indicates for the purpose of increasing the processing speed.

In the registration items in the member management table, an area code for preparation of statistical data or the registered member and for classification and assignment may be provided.

Further, present invention provides the system as described above, wherein when the member is designated as a reference person, a member in parent-child relationship with said member is extracted and displays parent member, child member and grandchild member together with the reference person as a list, said system further comprising means for executing the following steps of:

(1) making a code of a member selected in a member list extracted by designating a specific condition as a reference person code (“reference person CIF”);

(2) acquiring information of the reference person from the member management table based on the reference person CIF and of storing the information in a reference person display area;

(3) extracting codes of all members in parent relationship of the reference person from the relationship management table (“parent CIF”) and classification thereof based on the reference person CIF, acquiring each information from the member management table and priority rank of classification from the classification table, and storing the information in a parent member list display area from a member with higher priority rank;

(4) extracting codes of all members in child relationship of the reference person from the relationship management table (“child CIF”) and classification thereof based on the reference person CIF, acquiring each information from the member management table and priority rank of classification from the classification table, and storing the information in a child member list display area from a member with higher priority rank;

(5) extracting codes of all members in child relationship of a child member at the uppermost part of the child member list display area (“grandchild CIF”) from the relationship management table based on a child CIF at the uppermost part of the child member list display area and classification thereof, acquiring each information from the member management table and priority rank of classification from the classification table, and storing the information in a grandchild member list display area from a member with higher priority rank;

(6) displaying the display area;

(7) judging whether or not the user has selected a member other than the uppermost member in the child member list display area (If selected, advance to Step (8). If not selected, advance to Step (9));

(8) extracting codes of all members in child relationship of a child member selected in the child member list display area and classification thereof from the relationship management table based on the selected child CIF, acquiring each information from the member management table, and priority rank of classification from the classification table, and storing and displaying again the information in a grandchild member list display area from a member with higher priority rank;

(9) judging whether a reference person change button is pressed or not (If pressed, advance to Step (10). If not pressed, wait for the next instruction.); and

(10) making a code of a member as a reference person CIF who was selected by the user from each of the parent member list display area, the child member list display area, and the grandchild member list display area (Return to Step (2).).

Also, the present invention provides the system as described above, wherein a member in parent-child relationship is extracted by a member code set in the reference person, and degrees of relatives are displayed in a tree view in the order of relatives of closer degree, said system further comprising means for executing the steps of:

(1) acquiring information of the reference person member of the member management table based on the reference person CIF, and displaying the information in a tree view area;

(2) selection of the first degree relatives

(2-1) extracting a parent member from the relationship management table based on the reference person CIF, and additionally displaying the information under the reference person with one member in one step in the second column of the tree view area in the order of priority rank;

(2-2) extracting a child member from the relationship management table based on the reference person CIF, and additionally displaying the information under the parent member with one member in one step in the second column of the tree view area in the order of priority rank, whereby an abbreviation symbol is added after the name if a member with the same CIF is already displayed in the tree view;

(3) selection of the second degree relatives;

(3-1) performing the following processing in the order from higher position on members of the first degree displayed in the second column:

(3-2) extracting a parent member from the relationship management table based on the first degree relative CIF, and inserting and displaying the information between the corresponding first degree member and the next first degree member with one member in one step in the third column of the tree view area in the order of priority rank, whereby “selection of the second degree relatives” is not carried out if the member of two degrees before (the reference person) in direct line is the same member;

(3-3) “selection of the second degree relatives” is not carried out if an abbreviation symbol is attached to a member in the corresponding step of the first degree;

(3-4) adding an abbreviation symbol after the name if a member with the same CIF is already displayed in the tree view;

(3-5) extracting a child member from the relationship management table based on the first degree relative CIF, and inserting and displaying the information between the corresponding first degree member and the next first degree member with one member in one step in the third column of the tree view area in the order of priority rank, whereby “selection of the second degree relatives” is not carried out if the member of two degrees before (the reference person) in direct line is the same member;

(3-6) “selection of the second degree relatives” is not carried out if an abbreviation symbol is attached to a member of the corresponding step of the first degree;

(3-7) adding an abbreviation symbol after the name if a member with the same CIF is already displayed in the tree view area;

(4) selection of n-th degree relatives (n=3)

(4-1) performing the following processing respectively in the order from higher position on n−1-th degree member displayed in n-th column;

(4-2) extracting a parent member from the relationship management table based on n−1-th degree relative CIF, and inserting and displaying the information between the member of the corresponding n−1-th degree and the next n−1-th degree member with one member in one step in n+1-th column of the tree view area in the order of priority rank, whereby “selection of n-th degree relatives” is not carried out if a member of two degrees before (n−2-th degree relative) in direct line is the same member;

(4-3) “selection of n-th degree relative” is not carried out if an abbreviation symbol is attached to a member of the corresponding step of n−1-th degree;

(4-4) adding an abbreviation symbol after the name if a member with the same CIF is already displayed in the tree view area;

(4-5) extracting a child member from the relationship management table based on n−1-th degree relative CIF, and inserting and displaying the information between the corresponding n−1-th degree member and the next n−1-th degree member with one member in one step in n+1-th column of the tree view area in the order of priority rank, whereby “selection of n-th degree relative” is not carried out if a member of two degrees before (n−2-th degree relative) in direct line is the same member;

(4-6) (selection of n-th degree relative) is not carried out if an abbreviation symbol is attached to a member in the corresponding step of n−1-th degree;

(4-7) adding an abbreviation symbol after the name if a member with the same CIF is already displayed in the tree view area;

repeating Step (4) until “n” reaches a predetermined number by progressively increasing “n” by one in Step (4) after the procedure of (5) above, and completing the processing if “n” reaches the predetermined number.

Further, the present invention provides a system as described above, wherein said system extracts up to any degree of relative as desired and displays whether a relationship route is made up using member codes of two members as set to the reference person, said system further comprising means for executing the steps of:

(1) setting one of the two members for tracing the relationship as a regular member, and the other as a sub-member, storing a setting condition to trace whether the sub-member is connected with the regular member, and initializing array area in the memory for temporarily storing retrieval result;

(2) storing the setting condition as to up to which degree should be searched at the furthest or whether the shortest route should be searched or all routes should be searched as designated by the user when processing is performed;

(3) extracting the first degree member in parent-child relationship of the regular member;

(3-1) judging whether ia-th (i=1 to n) member is a sub-member or not among the number of records “na” of the extracted first degree member;

(3-1-1) if it is a sub-member, executing the processing of Step (3-1) to the record of the next first degree member by storing the route from the regular member in array area of the memory;

(4) if it is not a sub-member, extracting the second degree member in parent-child relationship of ia-th member of the first degree;

(4-1) judging whether ib-th (i=1 to n) member is a sub-member or not among the number of records “nb” of the second degree extracted;

(4-1-1) if it is a sub-member, executing the processing of Step (4-1) to the record of the next second degree by storing the route from the regular member in array area of the memory;

(4-2) if it is not a sub-member, judging whether the same member as ib-th member of the second degree is present at higher position in the route or not;

(4-2-1) if it is present at higher position, executing the processing of Step (4-1) to the record of the next second degree member by interrupting the processing;

(5) if it is not present at higher position, extracting the third degree member in parent-child relationship of ib-th member of the second degree;

(5-1) judging whether ic-th (i=1 to n) member is a sub-member or not among the number of records “nc” of the third degree extracted;

(5-1-1) if it is a sub-member, executing the processing of Step (5-1) to the record of the next third degree member by storing the route from the regular member in array area of the memory;

(5-2) if it is not a sub-member, judging whether the same member as ic-th member of the third degree is not present at higher position in the route or not;

(5-2-1) if it is present at higher position, interrupting the processing and executing the processing of Step (5-1) to the record of the next third degree member by interrupting the processing;

(6) if it not present at higher position, extracting the fourth degree member in parent-child relationship of ic-th member of the third degree;

(7) repeating the procedure by progressively increasing the value up to the degree of the number as set in advance, and performing the following processing in the final degree member:

(7-1) judging whether ix-th (i=1 to n) member is a sub-member or not among the number of records “nx” of the final degree extracted;

(7-1-1) if it is a sub-member, storing the route from the regular member in array area of the memory, and advancing to the next record of the final degree;

(7-2) if it is not a sub-member, advancing to the next record of the final degree. If the record of the final degree is completed up to “n”, performing processing by progressively increasing by one the number of records of the degree one step before;

(7-3) if the number of recording of the degree one step before is completed up to “n”, performing processing by progressively increasing by one the number of records of the degree one step before;

(8) performing this procedure until the number of records of all degrees is completed;

(9) rearranging retrieval results stored in array area of the memory from the member of lower degree in the route;

(10) displaying the first of the retrieval results in the tree view area; and

(11) displaying the route selected by the user among the retrieval results in the tree view area if the user designates the change of the retrieval result display in the pulldown list box.

Still other objects and advantage of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a drawing to show an example of a relationship chart;

FIG. 2 is a drawing to show an example of various types of information associated or linked with each other;

FIG. 3 is a drawing to explain an example of a family tree as generally known;

FIG. 4 is a drawing to explain an example of human relationship or connection;

FIG. 5 is a block diagram showing an embodiment of an associating information management system according to the present invention;

FIG. 6 is a table showing an example of a member management table;

FIG. 7 is a table showing an arrangement example of a relationship management table;

FIG. 8 represents tables, each showing an arrangement example of a master table;

FIG. 9 is a flow chart to explain an example of flow of associating retrieval processing of the associating information management system according to the present invention;

FIG. 10 represents tables, each showing an example of retrieval condition and output condition;

FIG. 11 is a drawing to explain a case where synchronous system is used;

FIG. 12 is a drawing to explain an example of association in parallel using parent selection group and children selection group;

FIG. 13 is to explain an example of association in series based on concordance or agreement of categories;

FIG. 14 is an illustration to explain an example of an import between database of LL system;

FIG. 15 is a drawing to explain media for connecting related items;

FIG. 16 is to explain association in a file management software such as Explorer;

FIG. 17 is a chart to explain partial association in a file of various types of data;

FIG. 18 is a chart to explain association of other files;

FIG. 19 is a chart to explain a case where items are associated by providing a plurality of management tables;

FIG. 20 is a drawing to explain a customer management method of card type as commonly in use;

FIG. 21 is a drawing to explain an example of the relationship management table in the present invention;

FIG. 22 is a drawing to explain child relationship;

FIG. 23 is a drawing to explain parent relationship;

FIG. 24 is a drawing to explain parent-children relationship;

FIG. 25 is a drawing to explain a route between a user and a person whose relationship is to be searched;

FIG. 26 is a drawing to explain connection based on parent-children relationship in the present invention;

FIG. 27 is an illustration to explain an example of a screen of a member introduction pedigree of the present invention;

FIG. 28 is an illustration showing an example of a screen to search member relationship retrieval in the present invention;

FIG. 29 is a drawing to explain how to search a pedigree in the present invention;

FIG. 30 is a block diagram showing software configuration of a system according to the present invention;

FIG. 31 is an illustration of a main menu screen of a system for carrying out the present invention;

FIG. 32 is an illustration showing a member information input screen of an embodiment of the present invention;

FIG. 33 is an illustration of a box item input screen of an embodiment of the present invention;

FIG. 34 is an illustration of a box item input screen of the embodiment of the present invention;

FIG. 35 is an illustration of an area code input screen in an embodiment of the present invention;

FIG. 36 is an illustration of a relationship classification registration screen of an embodiment of the present invention;

FIG. 37 is an illustration of a relationship classification registration screen of an embodiment of the present invention;

FIG. 38 is an illustration of a relationship input screen of the embodiment of the present invention;

FIG. 39 is an illustration of a screen of a member introduction pedigree (parent, children and grandchildren) in an embodiment of the present invention;

FIG. 40 is a drawing to explain a scope of pedigree indicated in the embodiment of the present invention;

FIG. 41 shows details of the display screen of FIG. 39;

FIG. 42 is a drawing to explain a route to be searched in the relationship retrieval;

FIG. 43 is a drawing of an example of simultaneous use of the relationship management table and the relationship vector table;

FIG. 44 is a drawing to explain an example of a method to connect the relationship;

FIG. 45 is a drawing to indicate an example of linking of related persons classified in groups;

FIG. 46 is a drawing to indicate an example of a relationship pedigree prepared by reference object center display; and

FIG. 47 is a drawing of an example of a relationship map prepared by position time series display.

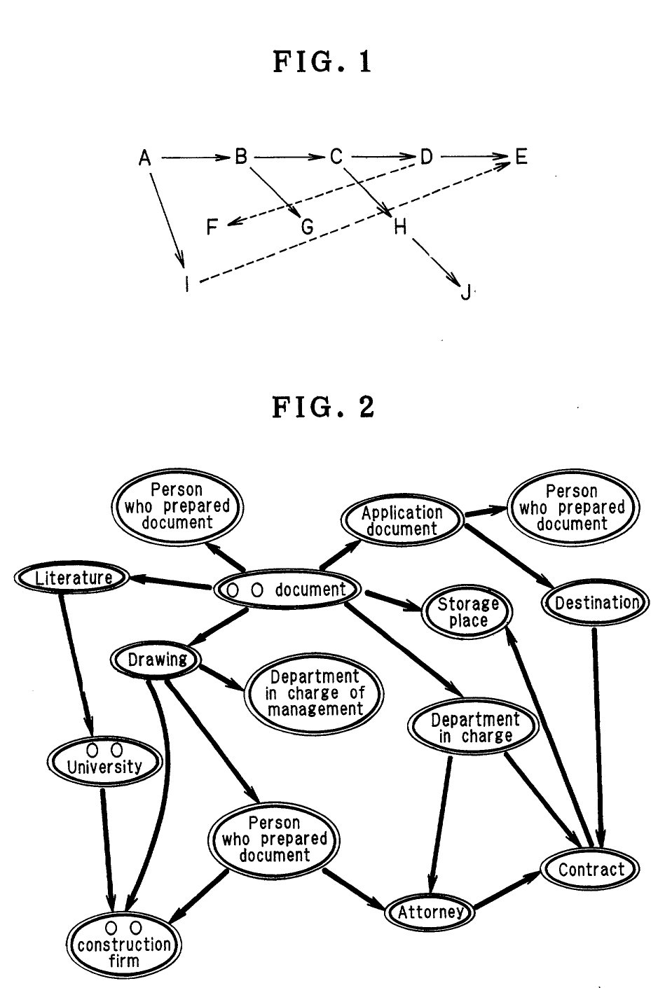

### DESCRIPTION OF THE PREFERRED EMBODIMENTS

Description will be given below on embodiments of the present invention referring to the drawings.

In FIG. 5, an input processing unit 1 performs input of various types of data such as registration, updating, deletion, etc. to the data, and inputs various types of instructions such as retrieval, editing, outputting, etc. in a relationship management table 6, a member management table 7, a master table 8, etc. An output processing unit 2 performs data transfer and delivery processing to other equipment and devices via network or communication lines, outputs display of information and prints out picture relating the result of processing based on input screen of various type of instructions such as retrieval, editing, output, etc., and carries out setting, registration, updating and deletion, etc. of the data.

A data registration and updating processing unit 3 for data management performs various types of processing such as setting, registration, updating, deletion, etc. to the data based on the input of the input processing unit 1. For instance, registration/updating of member detailed information, registration/updating of history information, and related input are carried out. A retrieval processing unit 4 gains access to each data based on retrieval condition, which is set according to an instruction from the input processing unit 1 and carries out retrieval processing of member information. For instance, member pertinent retrieval, member history retrieval, member relationship retrieval, etc. are performed. An edit processing unit 5 carries out edit processing for outputting results of retrieval according to a preset output condition, which is set according to an instruction from the input processing unit 1. For instance, display of member introduction pedigree, display of information of n-th degree relatives before and after and connection retrieval display, etc. are performed.

In the member detailed information registration/updating, information of the member is registered, and images relating to the member are displayed by image display function. Also, by pressing a postal number retrieval button after inputting the postal number, correct address is detected from the postal number. In the history information registration/updating, detailed information such as corresponding history, history of sales proceeds, etc. is registered for each registered member. Further, from the inputted history contents, a member is detected by history retrieval function. In the relationship input, it is registered from which point or to which point the connection is made and what kind of relationship it is. In the relationship classification, it is selected which relationship it has from parent or from child based on the preset contents, and the registered member is retrieved from the relationship classification using the member relationship retrieval function. In the relationship details registration, detailed information to the connection is inputted at the time of inputting, and retrieval is made using the detailed information inputted at the time of registration by means of the member relationship retrieval function.

In the member pertinent retrieval, an aimed member group is selected by repeatedly applying the results obtained by giving the conditions. In (AND) retrieval, the data is further selected by applying the current condition to the previous result. In (OR) retrieval, it reaches concurrence if either the result of the previous condition or the result of the current condition is satisfied. By the retrieval, the applicable member is normally displayed in a list box. When a non-applicable member is selected (clicked), members other than the selected members based on the condition are displayed in the list box. In the member history retrieval, a member is retrieved according to the history inputted for each member. For instance, when the history is used as buy-and-selling information, a person who has sold “◯◯” within the preceding week can be retrieved. In the member relationship retrieval, retrieval is made according to the relationship between members. For instance, when the relationship is used for exploiting customers by sales staffs, sales strategy can be set up for each area by registering expectation rate for each customer.

In the member introduction pedigree, persons to be referred are displayed, who are within two degrees in senior direction and in junior direction respectively. By changing the persons to be referred, all relevant persons can be referred. In the display of n-th degree relatives in senior and junior directions, based on the persons to be referred, the relevant persons are displayed in different colors to five degrees in senior direction and in junior direction respectively (in 10 degrees in total), and lists of senior members and junior members are displayed on one side of the screen. In the connection retrieval, any two persons as desired are specified, and it is retrieved whether there is connection between the members.

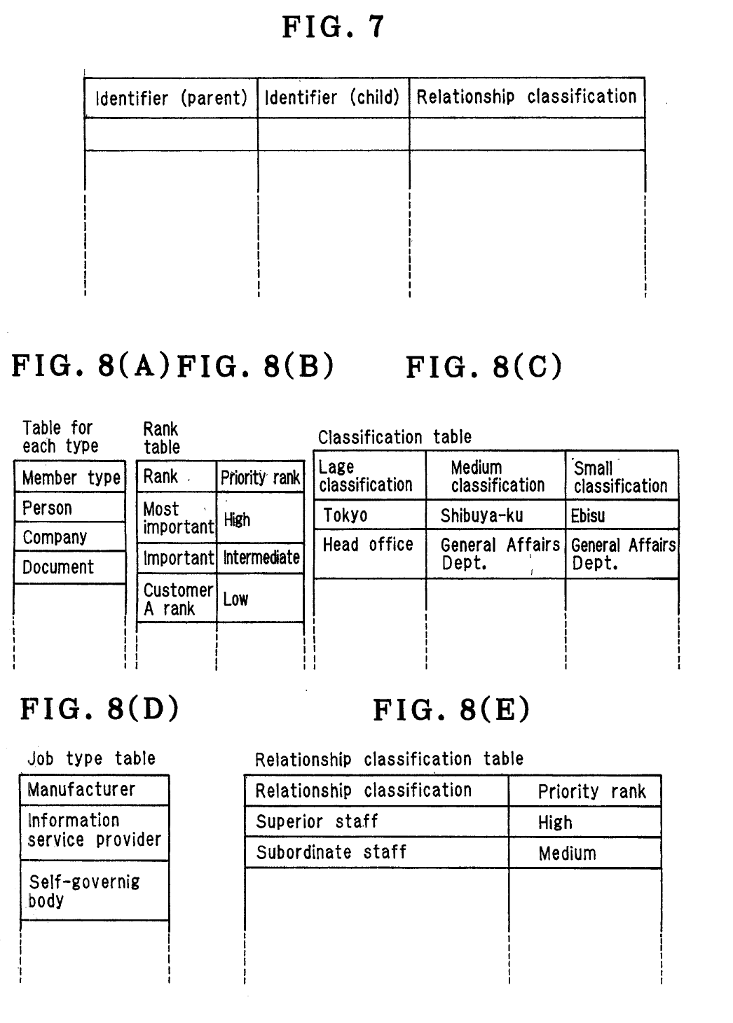

A relationship management table 6 is a table for finding association (linking) on one-to-one basis on various types of individual information according to the identified information. In the present invention, the identification information includes identifier, identification number, identification code, ID, ID number, CIF. Further, it includes information of file location table (hereinafter referred as “FAT”) under management of OS, individually identifiable attribute information, etc. For the association, information such as relationship classification to identify degree of relationship is added as necessary in the mutual relating direction, e.g. in the direction of: parent→child, master→slave, senior→junior as shown in FIG. 7, or in reverse direction. In the relationship classification, for instance, in case it is related to a person, classification includes senior staff, junior staff, colleague, introduction, or hostility. In the relationship of school or college graduate list, classification includes year of graduation. In the relationship of non-person object, ownership is included. In the relationship in a company, classification includes subcontractor, affiliation, or business partner. In the relationship used for personnel efficiency rating, classification includes direct subordinate, colleague, or belonging department. In the relationship used by financial institution in the management of relationship for guarantee, classification includes guarantor, joint surety, related building, or related land. In the relationship of document, literature or drawing, classification includes a person who prepared document, author, introducer, recommender, etc. These are set for each type of relationship. A plurality of these relationship management tables are used depending on the intended purpose when necessary.

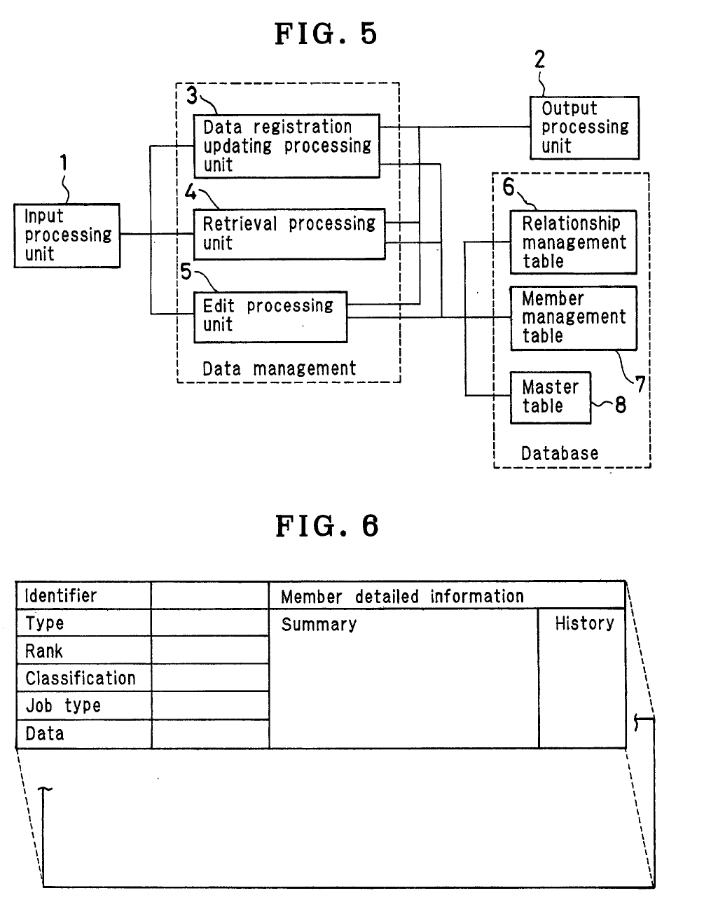

A member management table 7 stores information such as information of each member to match the identification information or related information to acquire the information, e.g. information such as FAT information, address recorded in FAT, type of file, position information, object, attribute, attribute information, etc. A member includes a person or an object such as person, document, literature, drawing, enterprise, head office or branch office, department or section, place, facility, organization, commodity, machine, equipment, etc., tangible or intangible management unit including facility, agency, organization, data, file and any type or category is included. For the member data to be managed, identification information specific to member, classification information of member for each type depending upon each member, or position information such as folder, relevant information given by physical address number, detailed information specific to member, etc. are registered. These are directly managed by member information or indirectly managed by the information to acquire member information. For instance, classification information for classifying each member as shown in FIG. 6 includes the information such as information for type of each member, rank, classification, job type, etc. Detailed information specific to the member is the information such as résumé, personal history, etc. Date is the date of registration and updating.

In the classification information, type, rank, classification, or job type of the member in the classification information are the conditions for editing and outputting the information for retrieval. Depending upon whether it is specified or not, it is judged whether it should be included as an object of editing and outputting or it should be excluded. In the information of summary (epitome), name is registered as the name of the member in case of a person, and the data such as sex, date of birth, present address, telephone, facsimile, E-mail address, working place, belonging department or section, job title, date of entry to the company, belonging group, hobby, personal history, résumé, photograph, etc. are included. In case of document, literature, or drawing, its name is regarded as member name, and the data such as literature classification, date of preparation, date of publication, person who prepared, publisher, author, summary of the content, words of recommendation, or words introduction are included. The information of personal history includes brief history of the member or updated personal history.

A master table 8 contains a definition table of various types of information, which is necessary to set registration classification so that minimally needed information is registered depending on each member information to the member management table 7 or to specify the condition for retrieval or edit output. For instance, these include tables classified by type, rank table, classification table, job type table, relationship classification table, etc.

Type classification table is to define the information of each type to identify the member as shown in FIG. 8 (A), i.e. to define person, company, document, etc. The rank table is to define rank and priority as shown in Table 8 (B). In general, the rank includes the following ranks: the most important, important, or customer A rank, customer B rank, customer C rank, and also priority such as high, intermediate, or low. As specific rank, there are ranks such as “in negotiation”, “re-negotiation possible”, or “no acquaintance”. In the non-person member type, there are movable property, real property, etc. For the purpose of using the rank for the members in listing, ranks include the person himself or herself, or a person already listed, and priority such as high, intermediate, or low is defined.

In the classification table, area, or department or section to be used in personnel efficiency rating or intra-company rating as shown in FIG. 8 (C), or commodity, group, etc. are defined as the items belonging to large classification, medium classification, or small classification. In the job type table, each of the job types such as manufacture, information service provider, self-governing body, architectural and building firm, insurance or financial organization, agricultural, forestry or fishery firm, or self-supporting business, etc. are defined.

The relationship classification table defines the relationship classification as shown in FIG. 8 (E) and the priority. In general classification, job types include senior staff, junior staff, colleague, introduction, hostility, etc. When parent is classified by school or college name, graduation is used. When a child is classified as a non-person object, it is classified by ownership. When the relationship between companies is classified, it is classified as subcontractor, affiliated partner, or business partner. When relationship is classified for personnel efficiency rating, there are classification such as direct subordinate, colleague, or belonging department or section.

The relationship classification plays a role of a “hand” to connect the registered members with each other, and it is defined by a code, which represents connection of two data (members). It is used to specify in which relationship these are connected with each other. When linking or associating a person with another person, or a person with an object, or an object with another object, there are differences in the degree of relationship, i.e. deep relationship, slight connection, insubstantial acquaintance, for instance. Priority is added to the relationship classification by taking these situations into account so that more important and more intimate relationship is displayed at higher position.

Next, description will be given on associating retrieval processing of the associating information management system according to the present invention.

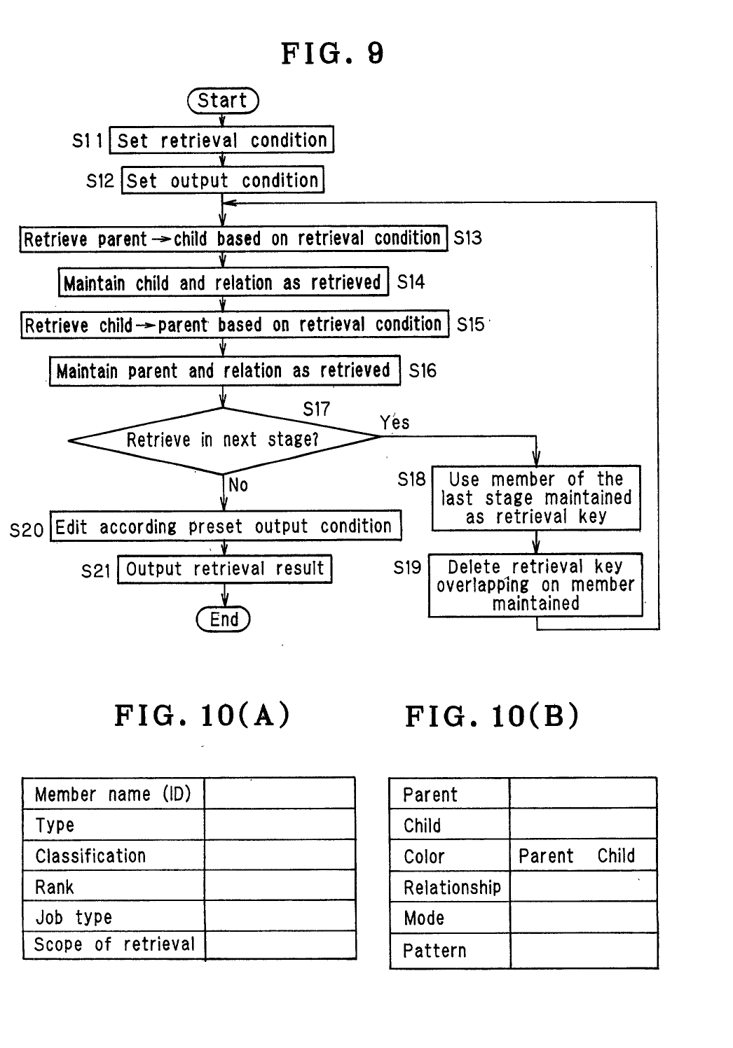

In the associating retrieval processing of the associating information management system according to the present invention, retrieval condition is set (Step S11) and output condition is set (Step S12) as shown in FIG. 9, for instance. As the retrieval condition, it is set as shown in FIG. 10 (A). For instance: which member type should be retrieved, which classification, rank or job type should be retrieved, and further, the range of retrieval i.e. up to which stage or up to which degree of relatives the retrieval should be made. As the output condition, it is set as shown in FIG. 10 (B). For instance: how far parents and children should be outputted, which color should be assigned as output color, whether relationship should also be outputted or not, whether parent direction or children direction should be outputted by arrows or not, in which direction (left or right) parents or children should be outputted, whether parent or children should be outputted in form of table or not, or whether it should be outputted in tree structure or not, etc., i.e. the mode and the pattern to be outputted should be designated.

Next, children are retrieved from parents according to the retrieval condition (Step S13), and the retrieved child and its relationship is stored in memory (Step S14). Similarly, parent is retrieved from children (Step S15), and the retrieved parent and its relationship are stored in memory (Step S16). Further, based on the output condition, it is judged whether the retrieval of the next stage should be performed or not (Step S17). If the retrieval of the next stage is needed, retrieval is performed in Steps S13-S16, and the member of the final stage retrieved and stored is used as a retrieval key (Step S18). If this is overlapped with the retrieved and stored members, the retrieval key is deleted (Step S19), and it is returned to Step S13, and the same procedure should be repeated.

In case it is judged in Step S17 that the retrieval has been completed, the retrieval result should be edited according to the preset output condition (Step S20), and the retrieval result thus edited is outputted (Step S21).

Next, detailed description will be given on the detailed information to be registered in member data. The information of the summary is not limited to the item name and it can be changed according to the intended purpose. For instance, in general summary items, the items such as registry number, date of the first business transaction, business details, memorandum of business details, etc. should be registered. When the information is used for insurance canvassing, the items such as insurance policy number, date insured, family details, medical history, etc. should be registered. When the information is used for personnel efficiency rating, the items such as employee number, date of entry to the company, family details, specific items, general evaluation, etc. should be registered. When financial institution manages the connection of guarantee, the items such as account type and account number, contract date, family details, whether there are liabilities on guarantee or not, assets, etc. should be registered. When the information is used for sales activities, the items such as membership number, date of the first visit, special features, hobby, and taste should be registered.

The history information is used for such purpose that the corresponding records in time series can be inputted. For instance, in general items, items such as date, details of arrangement, sales goal in numerical figure, achievability, carry-over to the following term, etc. should be registered. When the information is used for sales activities, the items such as data or purchase, name of the purchased product, quantity, amount of purchase, number of premium points, etc. should be registered. When the information is used for insurance, the items such as date of change of the amount insured, name and type of insurance and other details, number of payment of insurance premium, basic amount of insurance, total amount, etc. should be registered. When the information is used for personnel management, the items such as data, name of job, amount, self-evaluation, intra-company evaluation, etc. should be registered. When the information is used by financial institution, the items such as date of loaning, mortgage, amount of loan, amount of expected monthly reimbursement, balance, etc. should be registered.

When mutual relationship of members connected on the relationship input screen is inputted as additional information of relationship summary items, the items are set as appropriate depending on the intended purpose. For instance, when the information is used for general purpose, the items such as event, notable features of parent, notable features of child, date of introduction, memorial day in common, date of remarks, reliability of parent on child, reliability of child on parent, intimacy, evaluation (parent to child), evaluation (child to parent), etc. are registered. When the information is used for business transaction, the items such as receiving of order, order placement, subcontract, date of introduction, date of (the first) transaction, date of (the final) transaction, shareholdings, weight (ratio) of order placement, weight (ratio) of receiving of order, transition of relationship, details of business transaction, etc. are registered. When the information is used for insurance, the items such as hobby in common, special ability, health condition, the latest date of encounter, date of the first acquaintance, wedding anniversary, intimacy, number of years of acquaintance, hostility, remarks, etc. are registered. When the information is used for personnel management, the items such as year, department or section assigned, date of assignment, date of evaluation, date of transfer, ability, cooperativeness, tenaciousness, evaluation (parent to child), evaluation (child to parent), etc. are registered. When the information is used by financial institution, the items such as details of guarantee, mortgage rank (object), memorandum, date of guarantee updating, date of the first payment, date of the last payment, amount on guarantee, limit amount of guarantee, current nominal price (object), detailed relationship, etc. are registered.

Further, description will be given on embodiments, to which the associating information management system of the present invention is extended.

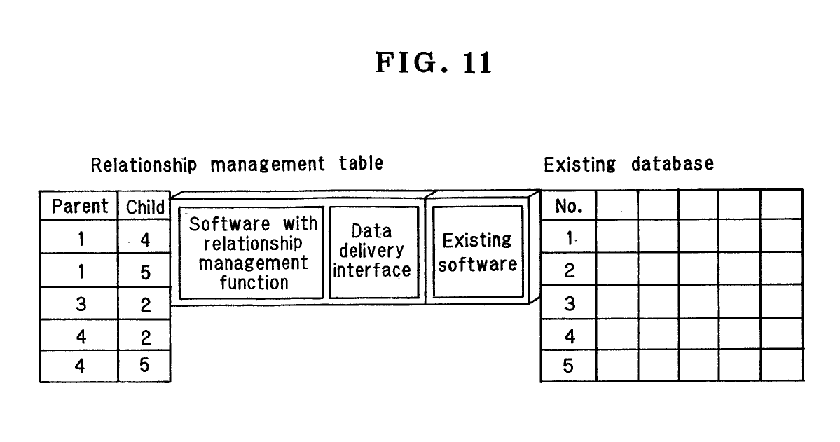

First, description will be given on synchronous system, in which the associating information management function of the present invention is provided to other database already built up and placed under management. To add the related management function to the existing database, there are two methods: a method to prepare the software under operation again from its beginning, and a method to connect a related management software having data delivery interface. The synchronous system refers to the latter. In the synchronous system, ID number specific to the data of the database is recorded in the relationship management table as shown in FIG. 11 without totally modifying the software of the existing database structure. That is, a plurality of different types of software are provided to one database. However, the database itself is often designed for the existing software. In this respect, the interface to receive the information from the existing software is contained in the related management software. In so doing, on the related management software, a data reference portion of the existing software can be utilized without developing basic data display portion. On the related management software, the data already registered are associated or linked with each other, and the relationship management such as pedigree display is contained in the software. It is possible to incorporate all functions of the existing software (by the function to execute external software) in the related management software so that it looks apparently that the related management portion is added to the existing system.

To utilize the synchronous system, it is necessary to monitor the change of ID due to adding, correction, and deletion in the existing software on the related management software. When the existing software allows the change of ID, the related management software must cope with the reassignment of ID number or an unchangeable ID must be added to the existing data. By applying the synchronous system, it is possible to shift to a system having cost-saving related management function without introducing a new system which is to replace the database system currently in operation.

Next, description will be given on automatic association or linking. It may be designed in such manner one or a plurality of any data registered in the member management table (such as the data consistent with a given condition, or data of selected category) are associated with one or a plurality of different data. In this case, the association in series, i.e. the association of a plurality of data selected by an arbitrary designation connected one after another and in series, is performed in the order rearranged by the user, or one by one.

Also, as the association in parallel, the data extracted by condition designation from all data, the data extracted in a category specific to each data, the data arbitrarily selected, or all data are displayed to a selected parent group or a selected children group, and association is carried out by the designation of parent and children, and the relationship management table is prepared.

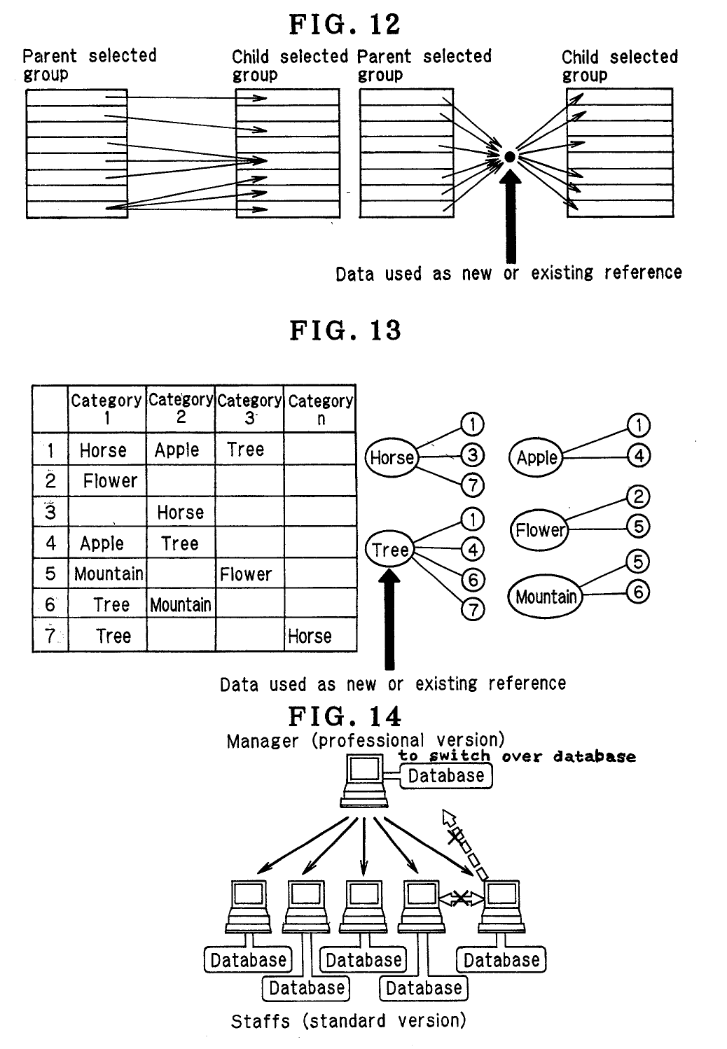

In this case, if there is one member each in the parent selected group and the children selected group as shown in FIG. 12 (A), one-to-one association is performed by directly regarding each of these as parent and child. Also, where there are one parent selected group and a plurality of children selected groups, association of the parent is performed with each of the children on one-to-one basis, and on one-to-multiple basis as many times as the number of children. If there are a plurality of parent selected groups and one child selected group, one child is associated with each of the parents repeatedly on one-to-one basis, and further, on multiple-to-one basis as many times as the number of parents.

If there are a plurality of parent selected groups and a plurality of children selected groups, association on one-to-multiple basis is performed as many times as the number of parents or association on multiple-to-one basis is performed as many times as the number of children. As shown in FIG. 12 (B), the association on multiple-to-multiple basis is performed, i.e. a new or existing data α is designed between parent and child. All of the parent-designated data are regarded as parent of α, and all of the children-designated data are regarded as children of α, and these are stored in the relationship table. Each association is performed by general processing starting procedure using an association button or by drag-and-drop method.

As the association in parallel based on the consistency of category, a plurality of category registration frames are provided for each of the data in the member management table as shown in FIG. 13. The data consistent with the selected category such as horse, tree, apple, flower, mountain, etc. are selected, and these are associated with a new or existing data. For instance, this can be applied similarly to the data, which contains the same attribute or the same words such as the same group.

Now, description will be given on import between databases. When the associating information management system of the present invention is divided into a plurality of grades such as professional version, standard version, or personal version, it is possible to build up a pseudo network such as LL system including a manager and one or a plurality of staffs as shown in FIG. 14. Here, the professional version is defined as a version where there is no limit to data registration, history information can be inputted and retrieved, relationship detailed information can be inputted and retrieved, and a plurality of databases are allowable. The standard version is defined as a version where there is no limit to data registration, and history information can be inputted and retrieved. The personal version is defined as a version where registration is limited to several hundreds of items and a common database is used. The professional version contains a plurality of databases and these can be used by switching over to each other. The database can be an object of operation regardless of wherever it is on the other personal computers on LAN so far as it is not within the same folder.

Using the professional version, the manager can refer to and update database of staffs in addition to the manager's own database. Using the standard version, the staff cannot operate any more except the staff's own database. If data of other person is copied without permission, 4-rank ID and password are provided for each database, and it is prohibited to enter inside. By the professional version, it is possible to refer to and update a portion of the relationship detailed information, which cannot be found in the standard version, and it is possible to write on the database of a staff beyond the staff's own management.

The data associated within the range of up to n-th degree of relatives from an arbitrarily designated data is turned to an object of import. A code not overlapping with the data identification code on incorporation side is re-assigned and is imported. At the time of importing, if there are the same data on the incorporation side and on the implantation side, association is performed further on “the person in question” (relationship classification that it relates to the same data). If it is not definitely certain whether the data are the same or not, the user is asked to select whether a message should be provided to the user or it should be judged as the other data.

Next, description will be given on operation on the file management software.

When we look at the current status of the file management software (such as Explorer), the file management software is regarded as a large storage place for accommodation as a whole, and files are merely divided and placed in classifiable container boxes called folders, and it is not possible to search file relationship. However, for the management of files, it would be much easier for everybody to arrange and put in order if the connection between the files is known.

For instance, if it is supposed that there is a document A prepared using WORD and there is a document A′ which is prepared by correcting the document A. In this case, if there is relationship between these two documents, it means that it cannot be indicated except by the file name or by the fact that the documents are stored in the same folder or there is relationship in property. If these documents are identified by the property, and in case the documents A″, A′″, A″″, etc. are prepared, the fact that the document prepared subsequently is related with the document previously prepared must be entered in the property of all documents prepared so far.

When the document A″″ is prepared, and if only the property of the document A′″ is changed, it is not possible to find that there is relationship between the documents A and A″″ unless the properties are checked by going back one by one. Similarly, what is related to different file format (such as document, table calculation, image, CAD, etc.) cannot be summarized by the person who prepared the documents if these are classified by categories. If the documents are classified according to the type of file, inconvenient situation may arise that unification in business operation cannot be achieved.

In this respect, if the associating information management function of the present invention is added to the file management software, the stored places may be arranged in easily intelligible folder such as classification by category or by the person who prepares. By displaying the relationship chart of the files related, it is possible to summarize by the history of change or by business project.

In the file management software, there are provided functions such as an automatic associating function, a function to display pedigree such as parents, children and grandchildren, a function to display tree type pedigree such as the relatives within 5th degree before and after, a function to search route between relatives of a certain relationship such as connection search, or a function such as relationship input screen. Association can be carried out either by the use of relationship input screen or by drag-and-drop method. When the associated files are copied on Explorer, all associations are not copied, but association with the original file is made up by duplication. If the file is a concealed file, it is displayed in such manner that association is not carried out when the concealed file is set as not to be seen. Association is performed not by file name, but the file is turned to identification information, and position information or physical address number of folder can be used.

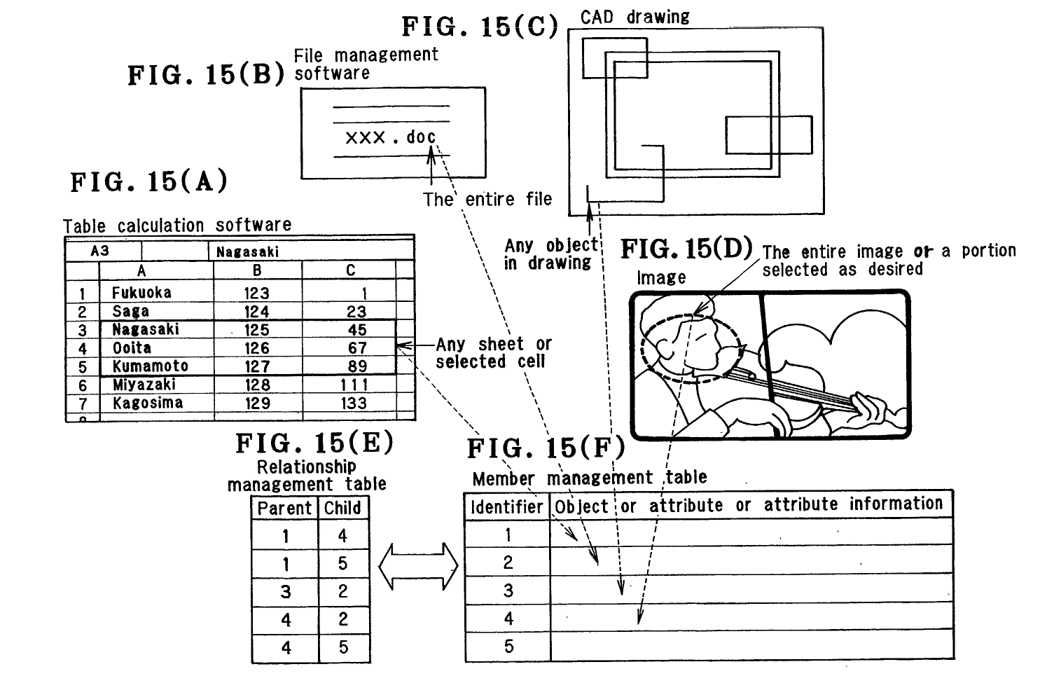

Description will be given now on a medium to connect the relationship. If the medium is included in the concept of the associating information management function of the present invention to connect the relationship, information such as audio information, time information, position information, etc. i.e. attribute specifiable as an independent object even when a part of it is extracted or an information having such attribute, are handled as the object for management and these are placed in an array such as database. For instance, as shown in FIG. 15, on an arbitrary sheet or a selected cell in the table calculation software (A), the entire file of the file management software (B), an arbitrary object in a CAD drawing (C), an entire image of the image (D) or an arbitrary selected part of it, related information is stored in the member management table (F) using a key to specify back number of the array or address as identifier. Then, association is performed in the relationship management table (E). As a result, the information can be used not only in Explorer, but also in a new or existing application.

Now, description will be given on the association in a file management software such as Explorer. In Explorer or the like, the folder to be displayed and file name are stored in directory pass such as file allocation table (“FAT”) under management by OS. In order to provide Explorer with the associating information management function of the present invention, there are the following methods: \mathring{1} a method to have the member management table at a place other than FAT; \mathring{2} a method to use FAT itself as the member management table; and \mathring{3} a method to manage the relationship in such manner that the relationship management table has FAT information itself, and not the concept to manage ID.

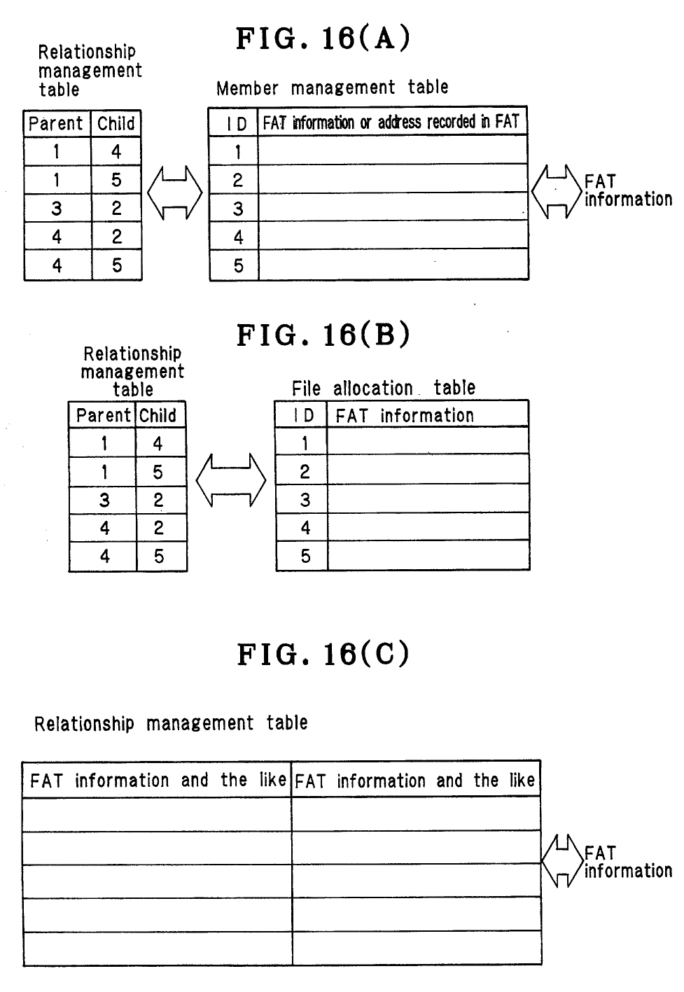

In the method \mathring{1} to have the member management table at a place other than FAT, ID and file information recorded in FAT are copied in the member management table shown in FIG. 16 (A) and is used, or information such as physical recording position address in FAT is used. In the method \mathring{2}, there are a case where ID is given by changing the shape of FAT itself in the stage of OS designing as shown in FIG. 16 (B), or a case where information such as physical recording position address in FAT is directly put in the relationship management table and association is performed, or a case where FAT information itself is stored in the relationship management table and is associated. In the method \mathring{3}, FAT information itself can be identified one by one. Therefore, relationship management can be accomplished by recording in the relationship management table without specifically putting ID as shown in FIG. 16 (C). According to this method, FAT information or physical recording position address in FAT is stored in the relationship management table, and the relationship management table must be changed simultaneously with the change of file or folder.

As for the object to connect the relationship, regardless of whether it is a file or a folder, it can be achieved if it can be processed on the file management software even on a network. An Explorer-like object, which has the same function as Explorer belongs to individual application, which has the same function as Explorer, has file information in a specific area instead of FAT, but the functions are the same.

In the following, description will be given on a concrete execution example. First, an area to specify file and the like to be associated is provided somewhere on the screen, and an object to be associated is put into it by inputting or drag-and-drop. In each specified area, one or a plurality of places can be designated such as list boxes. As already explained in connection with FIG. 12, association can be performed on one-to-one bases, one-to-multiple basis, multiple-to-one basis or multiple-to-multiple basis. Then, an arbitrary file is selected. For instance, pedigree display is selected on menu by pedigree display button or by right-hand click, and it is transferred to a screen to display the relationship. Further, a connection searching screen to trace the relation of two or more files or a screen to display all relationship of the relatives of n-th degree before and after may be provided, and this may be performed from any screen as desired. When the associated file or folder is copied, it is possible to select whether the relationship should be taken over as the origin or copying or it is simply the association of the origin of copying with the destination of copying.

Next, description will be given on partial association in a file, which contains a diverse types of data. Unlike the case of the file management software, in which the association of file name and folder name is involved, in the partial association of diverse types of data, the related application and the data file prepared by the applications must be provided with related information and related information processing functions. The same applies to the case where the relationship management is entrusted to the management software on OS side such as Explorer or in the case where the data are associated within each of the applications.

For instance, description is given here on an image processing software and an image file prepared by the software. In general, the information in a file prepared by an application has various types of format depending upon utilization environment in addition to image information, e.g. file format having attribute information such as shape, object, color, color saturation, brightness, alpha channel layer information, change history, etc. (such as PSD of Photoshop), of a format having image information only. The attributes held in the file has different information amount depending upon file format and the application used. In the case where a part cut off from an image is to be copied and pasted via clip board, only the data at the moment of copying should be the object of concern. Even when the attributes are taken over, there is no need to take over file information. However, in order to have a relationship and to maintain continuous relationship, it is necessary to cope with the change of the contents and the transfer of the related scope. Therefore, it is necessary to keep in memory in the file itself as to which attribute information the associated portion is and in which scope. In the image processing software, functions are needed to display the relationship information stored in the file and to monitor the change. In this case, basic data is not stored by the use of the member management table, but the selection scope to be associated or characteristics of the data are recorded, and the data itself is present in the original file. Naturally, it is possible to copy the data itself from the original file and to record it in the member management table.

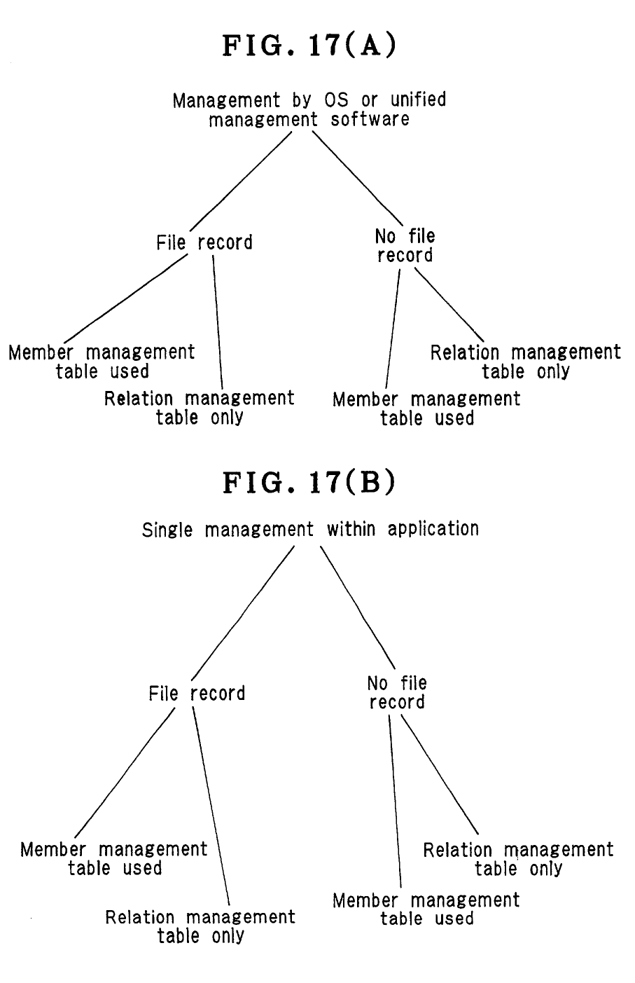

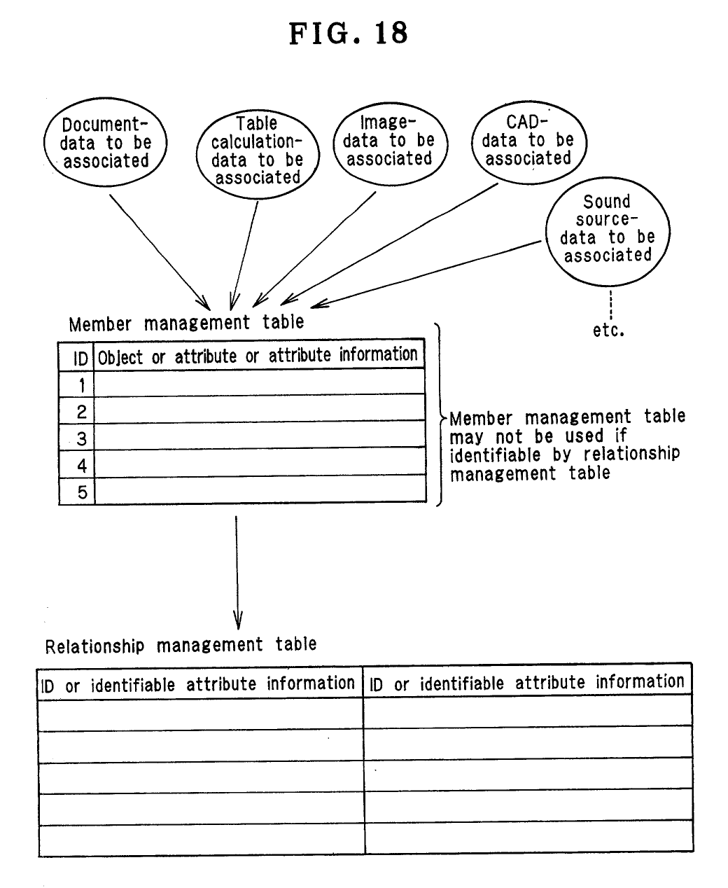

Specifically, as shown in FIG. 17, the file may have the relationship designation scope information, and the member management table and the relationship management table may be used. Further, in case the member management table is not used and the relationship is managed only in the relationship management table, or in case the information management is performed in the member management table or in the relationship management table, there are various types of utilization environment to match each combination of the conditions.

Next, description will be given on an example where a relationship layer is provided. A relationship layer to display transparent relationship designation scope is provided and is overlapped on the image data. The scope to be associated is designated within the image processing software, and this scope is displayed in the relationship layer. As for the attributes in the designated scope, the amount of information is different depending on each application (in addition the selected shape and object), such as color saturation, brightness, alpha channel layer information, change history, etc. Here, description is given on the selection scope and other attributes. A relationship information setting button and the like are provided in the image processing software. When the scope is selected by turning this button on, ID, type of file, directory pass, file name, selection scope, and other attributes are written in the member management table. At the same time, ID acquired at the time when the selection scope was written in the member management table is recorded together with the selection scope information in the image file as identification name of the designated scope. Individual information written in the member management table is associated with the other information on the screen of relationship input of the file management software of OS by the relationship input button or the menu by right-hand click. This relationship is written in the relationship management table. When a portion included in the relationship designation of the image data is corrected, it is asked whether the relationship designation scope should be changed or not by monitor function of the image processing software. If there is a change, the image file recording the information and the member management table are also changed.

In case the member management table is not used, file type, directory pass, file name, selection scope and other attributes may be directly written in the relationship management table and association may be carried out. However, if we consider an independent member to perform different association with the same designation scope and the same attribute on the same file, all data must be stored after turning them to identifiable formation specific to the member including ID.

In case the relationship information is not recorded in the image file, all information is recorded in the member management table or the relationship management table. The image processing software receives the information to be displayed on the relationship layer and the like, not from the image file, but from the external table. When the information is not managed by OS or unified management software or it is not managed by the application alone, but it is managed in an image application alone, there must be a relationship management table and a member management table specific to the application, and the function such as relationship input or pedigree display must be provided in the image processing software.

Description has been given above on the image. Recording and monitoring functions are needed for the combinations such as: word processor software and document file, table calculation software and book file, CAD software and drawing data, sound source software and sound source data, etc. As shown in Table 18, when the member management table is used, ID, file type, directory pass, file name, selection scope, and other attributes are recorded. For instance, in case of table calculation, sheet, cell, format information, etc. are recorded. In case of CAD, layer, line type, color, shape, etc. are recorded. In case of a document, page, format information, etc. are recorded. In case of sound source, time, wavelength, sound range information, etc. are recorded. When the information is written directly in the relationship management table, not detouring the member management table, file type, directory pass, file name, selection range, and other attributes are recorded in the relationship management table. These may be recorded in such manner that the data can be identified from each other. This can also be applied by the use of expression which can indicate relationship of the data in the unit of bit to connect the relationship such as absolute address in personal computer. In addition to screen and printing medium, input and display means using external communication means such as Web, ASP, PDA, etc. may be used. Basically, the functions to display the data connected in parent-child relation in the relationship management table in pedigree and to follow up one after another can be provided on data side of each software or on OS side of the computer. Further, connection retrieval function to trace and display the relationship between any data as desired may be provided.

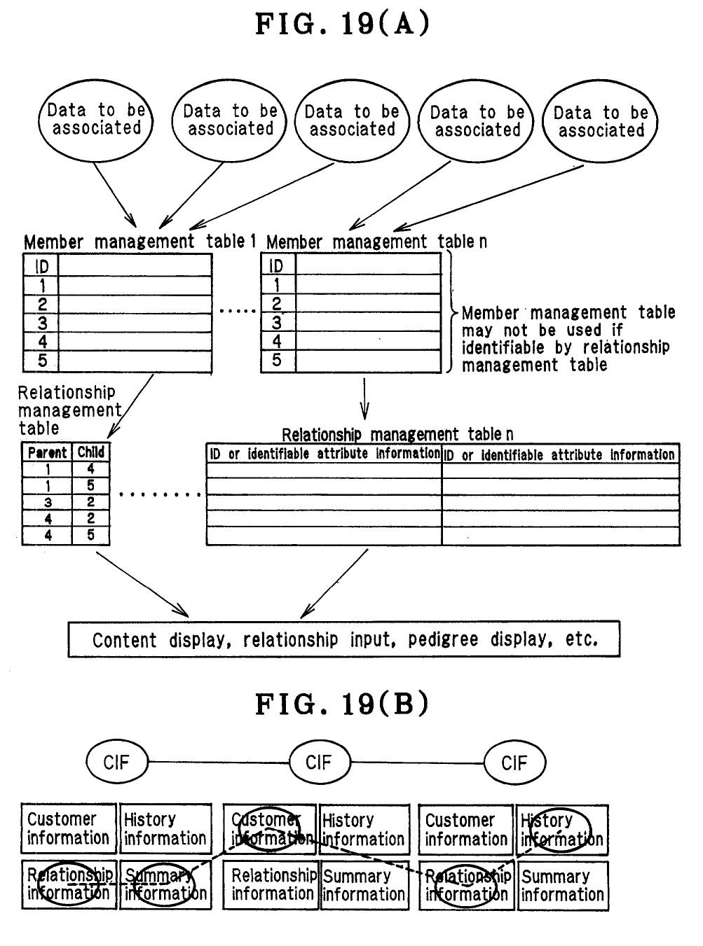

Now, description will be given on the case where association is carried out by providing a plurality of management tables. The objects to be associated are the registered members. In case it is wanted to have relationship between a history information and another history information or in case it is wanted to associate history with the relationship information, or an image with summary items of other member, it is not possible to express by a single member management table or a single relationship management table. To cope with such situation, not a single but a plurality of the member management tables or the relationship management tables may be provided in a single system as shown in FIG. 19. An N-th member management table is recorded in such manner as to which part of which information it relates to and of which identification information (CIF) in the member management table as basis. In N-th relationship management table, parent-child relationship associated in the screen for partial relationship input screen is recorded, and it is displayed on the pedigree for partial relationship display. In so doing, in addition to the relationship pedigree which can show only the relationship in head portion, the connection of each position can be identified.

The present invention is not limited to the above embodiments, and various modifications and variations can be made. For instance, in the above embodiments, description has been given on information of summary and information of history as detailed information of member data, while various types of information such as photographs or attachment files may be added, or the classified information according to identification code and detailed specific information may be registered for the same member.

As it is evident from the above explanation, the present invention provides the associating information management system by associating various types of information for management, and the system comprises at least a relationship management table for storing association of parents with children in identification information of the various types of information, and retrieval processing means for retrieving various types of information from parents to children and from children to parents. As a result, the relationship between the data can be expressed by parents (master; senior) and children (slave; junior), and tracing and display of the relationship can be easily performed through management by the relative relationship in degree rather than by generation. Moreover, by associating the registered data with each other, it is possible to connect the data so far as the relationship exists. It is also possible to trace the relationship route of the two members and to express the relationship in pedigree. Overlapped data can be distinguished by the relation of the same data without checking them one by one. Former family name and new family name can be made compatible through the association.

Also, the association can be performed not only between man and man, but between man and object or between object and object. The data of object can be managed when the data are mixed with the data of man. For instance, when an important document is prepared, which may be used extensively later in a company and which has business transaction with Government or public offices, it is possible to perform association to the person who prepared the document or to the section or department in charge of document control, and there is no need to seek the data in memory when it should be used.

Further, it is also easy to find books or map materials which were referred in the preparation of the document and to which section or to which branch office these books or materials belong. This can be accomplished by making association with the section or the branch office. If there is only a single clue such as “section”, “book”, “material”, or “document”, even when the details may not be in memory, it is possible to find necessary information by searching the relationship one after another. Naturally, not only the document but also the customer and a commodity such as the purchased vehicle can be associated with each other. If land is inputted as data, the transition of the ownership can be traced. Ambiguous data and uncertain data are not turned to the data of unidentified nature if these are associated in the new sources.

Next, description will be given on embodiments when the present invention is applied to a pedigree type human relationship management system. In this embodiment, the relationship chart which is expressible only 3-dimensionally can be managed on computer. When a part of the information is selected and indicated, it is possible to express the information on 2-dimensional paper.

In the following, basic concept will be described.

In the system of the present invention, when data is inputted, full retrieval functions are provided such as condition retrieval or furigana (Japanese vernacular) retrieval, avoiding the registration of overlapped data as much as possible.

For this reason, the data to be associated are placed under management of one-point concentration type, and useless connection is excluded. Even when there may be overlapped data, these are connected by the relationship of “the data of the same person”, when a pedigree is prepared, and it is displayed at nearby point.

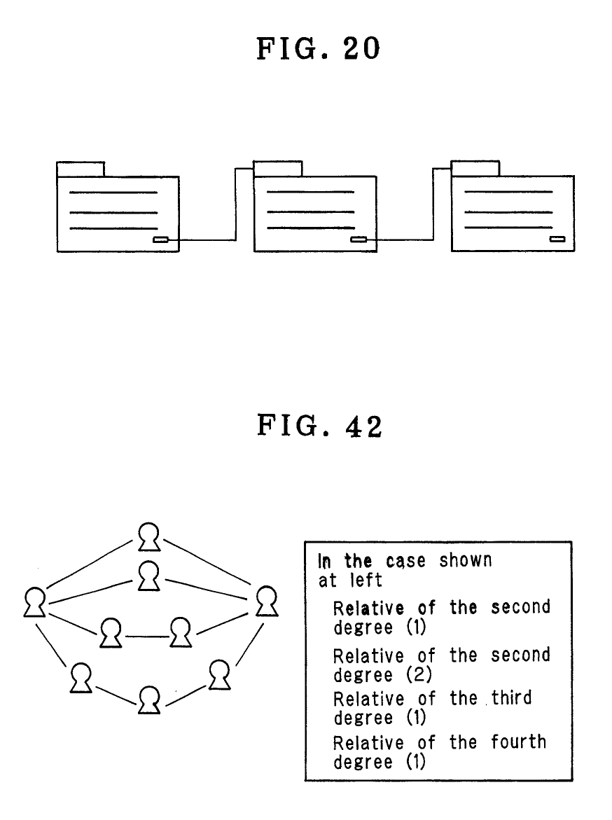

From the concept of general customer management, the data are stored in form of cards as shown in FIG. 20. Customer number and the like connected to the subsequent data are kept in memory in a part of individual data and are used.

In the system of the present embodiment, individual data and relationship data are placed under management in completely separated form. The data of relationship are also stored on one-to-one basis.

The basic file to express the relationship (table of database) has a customer number of parent, a customer number of child, and a relationship code.

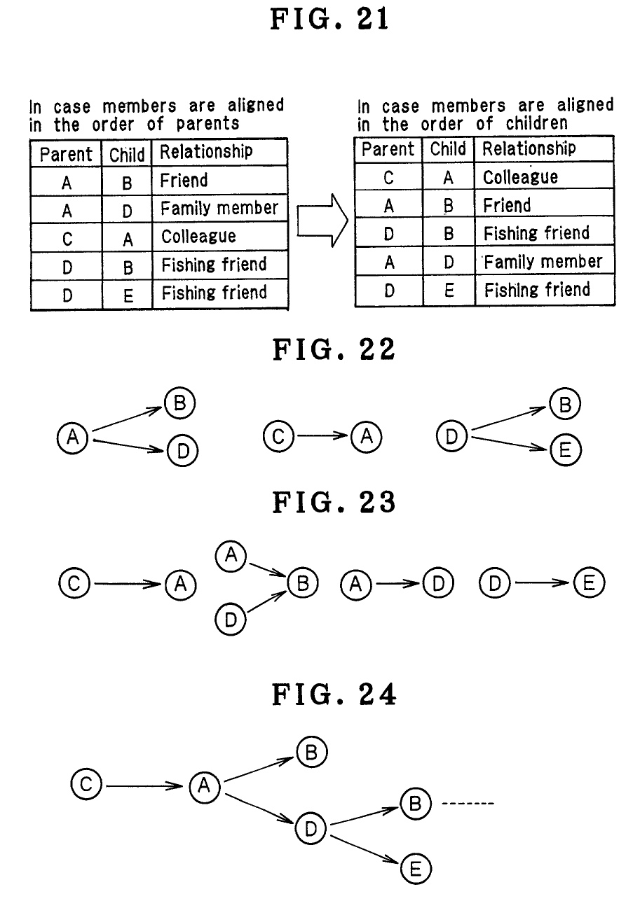

FIG. 21 shows an example of this table.

If this is arranged in the order of parents, it is found that one person has a plurality of children.

In the example shown in FIG. 21, Mr. A has two persons in child relationship, i.e. Mr. B and Mr. D as shown in FIG. 22. Mr. C has a child named Mr. A, and Mr. D has children named Mr. B and Mr. E.

Further, when this file is rearranged in the order of children, Mr. A has a parent named Mr. C as shown in FIG. 23. Mr. B has parents named Mr. A and Mr. D. Mr. D has a parent Mr. A, and Mr. E has a parent Mr. D.

When we observe parent-child relationship with Mr. A at the center, it is as shown in FIG. 24. By repeatedly following the chain connection in the system of the present embodiment, a pedigree is prepared. However, if the same person appears in the pedigree, the one which appears at a point closer to the person at the center of the pedigree is regarded as a regular route. Because the subsequent connection is overlapped on the regular route, it is represented by “ . . . ”.

As a result, even when the same person may appear repeatedly in the pedigree (i.e. in case of circulation), it is possible to search the related route in reliable manner.

Further, in the system of the present embodiment, connection does not mean a simple connection, but it has directivity, i.e. a connection from which to which.

This has a very important meaning when the pedigree is expressed in a tree structure.

As already described, by rearranging with the parent as the basis or by rearranging with the child as the basis, the directivity of the connection is clearly defined. By determining the person at the center, it is possible to find out the person connected to it.

Compared with the pedigree generally in use with special emphasis on the direct line such as “parent→grandfather→great-grandfather”, the relationship can be connected and seen to a further point in single-oriented combination of “parent→child→child→parent→parent”.

By providing the directivity of parent-child direction, the connection which could not expressed only by the relationship on equal basis can now be expressed in more clearly defined relationship such as subordinate, superior staff, former teacher, or former pupil.

By putting the priority to the relationship classification, it is possible to identify the intensiveness of the connection.

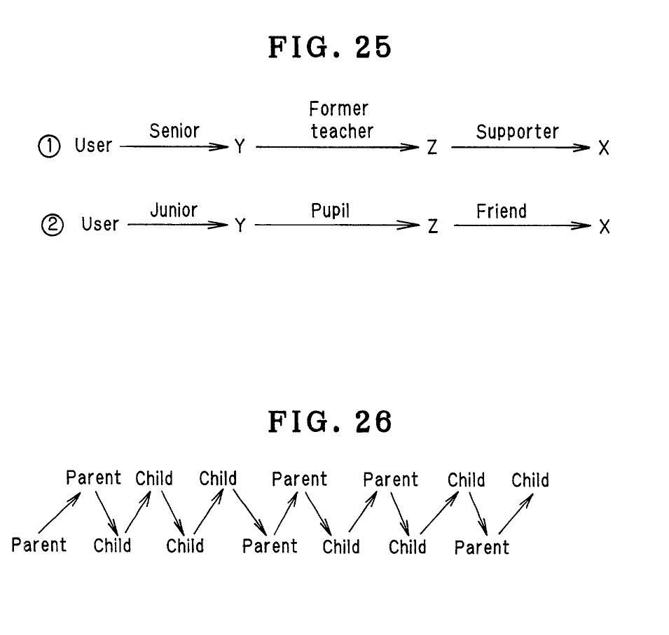

As shown in FIG. 25, when a user of the system of the present embodiment wants to have connection with Mr. X, it is found which route can be used more effectively.

As described above, by expressing the connection in parent-child relationship, the relationship can be clearly distinguished, and further, it is possible to distinguish the depth of the connection.

When a pedigree is expressed by generation, it is seen by means of direct line of “parent→grandfather→great-grandfather”. As a result, a definite flow is formed, which defines that senior is senior and junior is junior.

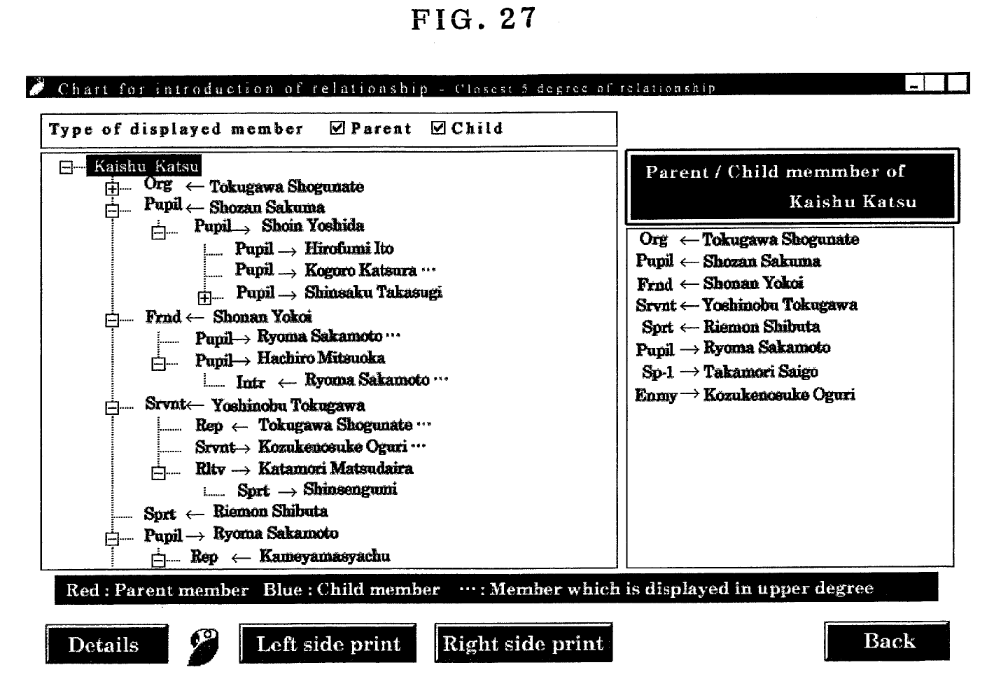

However, if it is expressed by the degree of relatives, there are only parents and children. If we give up the concept that parent looks down from above, and child looks up from below, the relationship can be folded in zigzag manner as shown in FIG. 26.

When a pedigree is prepared in the system of the present embodiment by utilizing the above logic, it is as shown in FIG. 27. A person to be at the center of the pedigree is assigned at the furthest left. From this person, a relative of the first degree is displayed by one step rightward regardless of whether the person of the first degree is parent of child. The persons of the second degree are also displayed by one more step rightward regardless of whether the person is parent or child. By repeating this procedure, the pedigree is developed in a tree structure and can be expressed on a plane.

As described above, by expressing the pedigree not by generation but by the degree of relatives, it is possible to freely trace the relationship and to display in form of a tree without fixing the direction of connection, i.e. parent direction, or child direction.

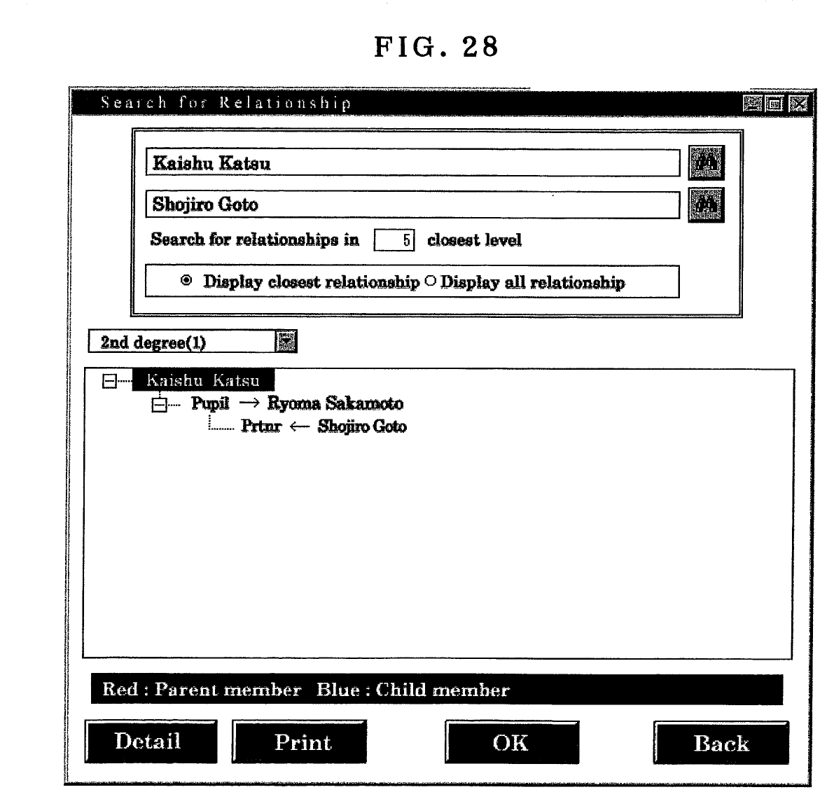

Further, in the present embodiment, only the connection of parent-child is entered in a file, which expresses only the relationship. By mechanically observing the relationship as “parent→child→parent→child”, the chain connection of the relationship can be continuously seen. However, from the limitation of screen display and printing display, the scope detectable at one glance is limited. If there is relationship further beyond the limit, tracing may be repeated mechanically in the same manner as: “parent→child→parent→child”, and the pedigree can be prepared. This is actually shown by a “member introduction pedigree (parent, child, grandchildren)”. This is a display of the direct line only, and the relationship can be displayed endlessly so far as the relationship exists. Further, in the function of relationship retrieval, as shown in FIG. 28, any two persons as desired can be specified, and it is possible to trace whether a relationship route is made up to these two persons.

In addition to the shortest relationship, all possible routes are searched within the specified degrees of the relatives, and the routes are displayed in a pedigree.

In this case, from the member used as reference, relationship is shown for 5 degrees in parent direction and 5 degrees in child direction, i.e. all members in the connection of 10 degrees are displayed.

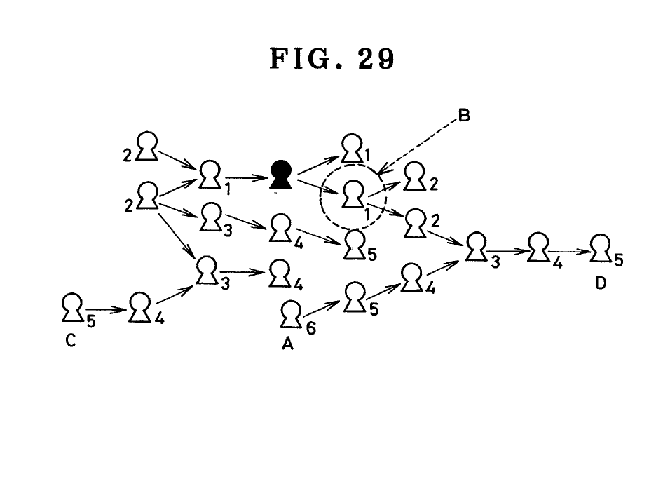

As shown in FIG. 29, a relative in the fifth degree means a person at the fifth position in the line. When it is seen from a person who is used as reference, Mr. A is in the sixth degree and it is beyond the scope of the pedigree. If Mr. B is used as reference, it is in the fifth degree, and Mr. A is shown on the pedigree.

When seen from Mr. C who is at one end, Mr. D is in the tenth degree, and the connection of eleven persons can be seen.

As described above, even the members who are beyond the display scope of the pedigree can be displayed by preparing a pedigree when the person used as reference is shifted.

In the following, description will be given on another embodiment.

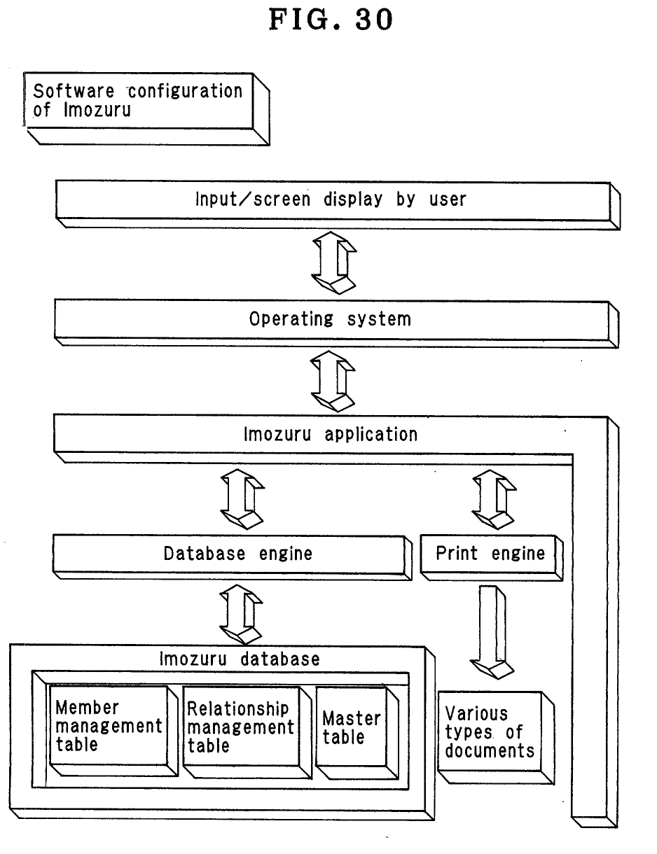

FIG. 30 is a system block diagram showing software configuration of a pedigree type human relationship management system of an embodiment of the present invention. As the database, it comprises a member management table for storing member information of individual and organization such as name or organization name, address, telephone number, etc. and a relationship management table for entering classification code to define relationship between a member registered in the member management table and another member relating to that member and to indicate type of relationship and priority rank of the relationship. The master table comprises a reference table such as classification table to define which relationship the classification code indicates and which priority rank it indicates.

Description will be given below on basic operating procedure and data processing in the system of the present embodiment.

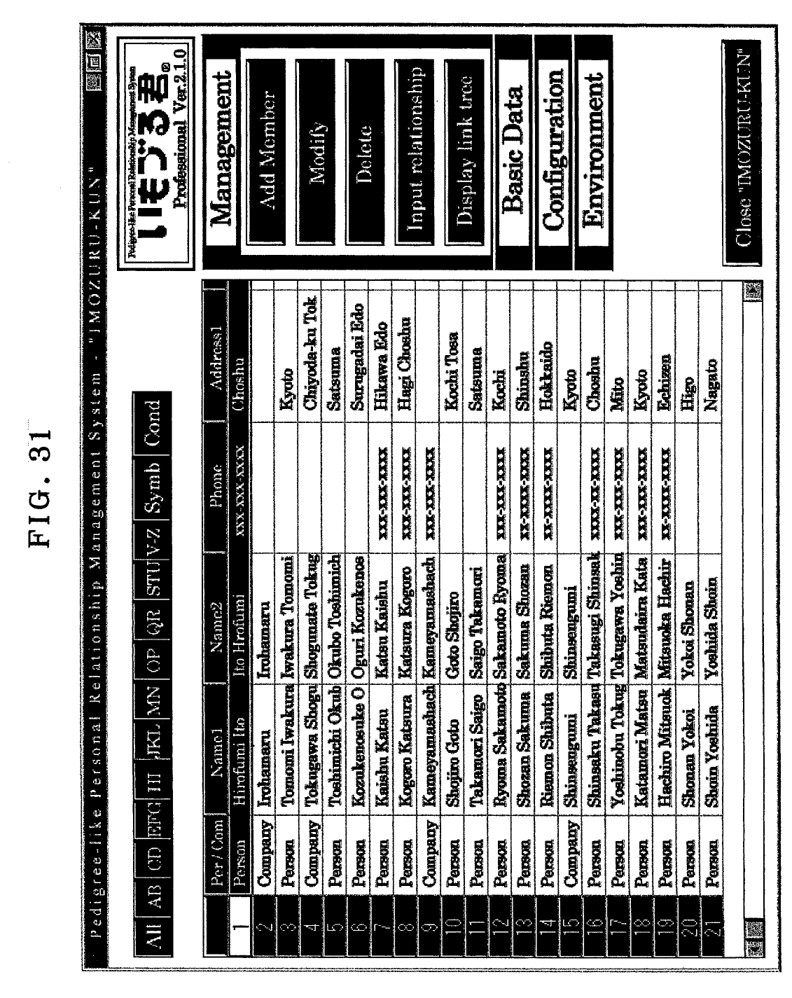

FIG. 31 is an illustration showing a main menu screen of the present system.

1. Member Management

Addition of Members

Correction of Members

Deletion of Members

In the above three processes, inputting, updating and deletion of the information of individuals and organizations are performed.

Relationship Input

Pedigree Display

In the above two processes, connection of members and pedigree are registered and displayed.

2. Data Materials

The condition is specified, and the corresponding member group in the registered members is extracted, and the result is outputted to document or text tile.

3. Basic Setting

Code setting and the like, which serve as the basis of the system, are registered and are placed under management.

4. System Management

Maintenance and management of database are carried out. button “Addition of members” on the main menu screen of FIG. 31 is pressed. From this picture, it is selected whether it is registration of an individual or registration of an organization. To register, the data such as name, furigana, date of birth, sex, address, telephone number, and facsimile number are inputted. Also, it is selected whether the data of this member may be made public to the other reader or not.

Now, description will be given on specific input items in this input screen.

1. Box

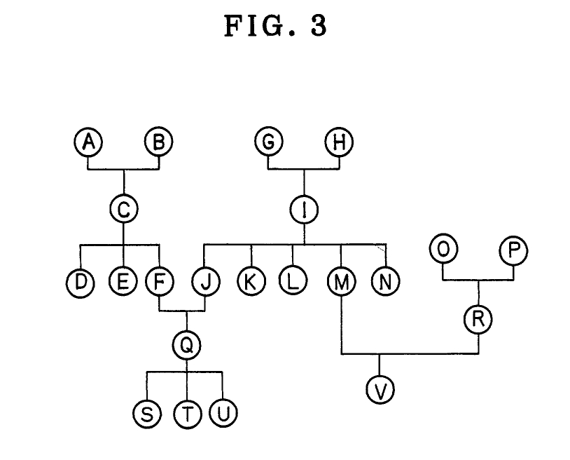

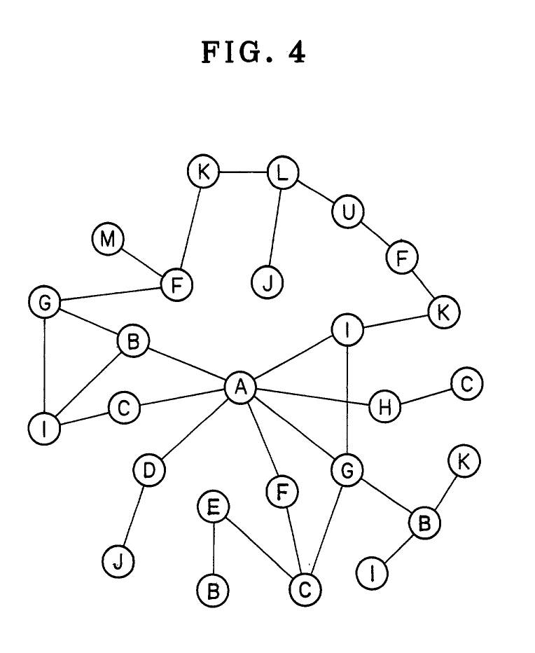

A box is a rank code. It indicates which type of partner to the user the member currently to be inputted is. FIG. 3 shows an example.

In the meaning that data cards of the member are assorted and stored in the box of rank, it is called a “box”. The box can define priority rank.

In the system of the present embodiment, unlike the customer management software to place only the customers under management, it is important to input a person, with whom the member has no acquaintance but wishes to have connection in future, or a person related to such a person. If a rank is set in the box, which means “no acquaintance”, it can be distinguished from the present customers.

By increasing the registered data and by connecting the relationship there arises the possibility to make a human relationship route to a person, with whom the member wishes to have connection. In such case, it can be retrieved whether human relationship route is connected or not by the “relationship retrieval” function.

2. Area Code

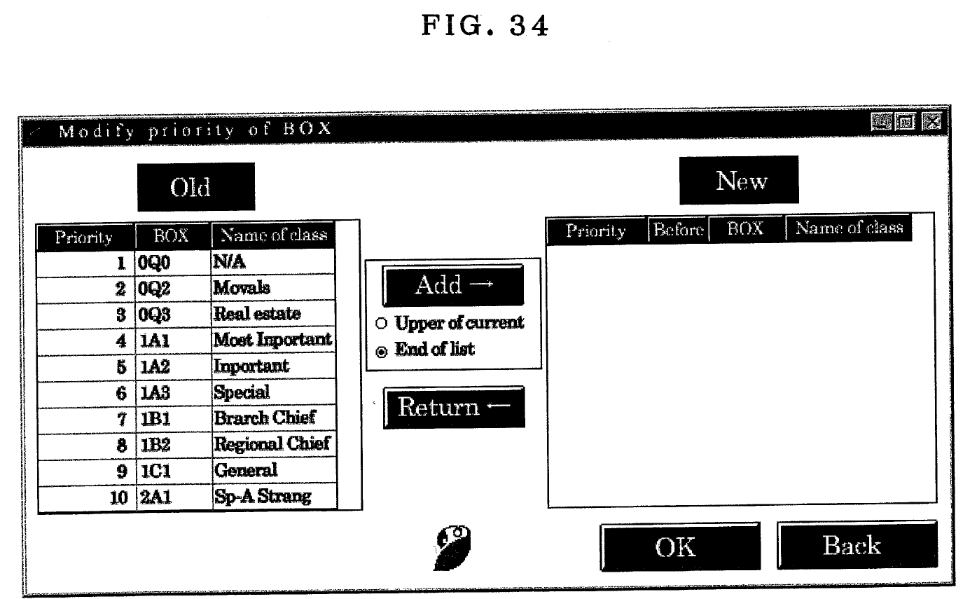

An area code is set for preparation of statistical data of the registered member and for assortment to the applicable classification. It is designated which of the items as classified by large classification, medium classification, and small classification the member now being inputted belongs, and number of items and ratio are displayed in graphs and the like. FIG. 34 shows an example of the area code.

The item of classification is classified into 3 stages, depending upon the purpose of data arrangement such as section or department and district under control, in addition to the address data such as “prefecture, name of city, town or village”.

When the system of the present embodiment is used, not for human relationship, but for object management, it can be applied not for area but for management classification.

Adequate examples are:

Stock control: warehouse, shelf, box

Car accessories: manufacturer, parts, components

Animals and vegetables: order, family, genus

3. Relationship Classification

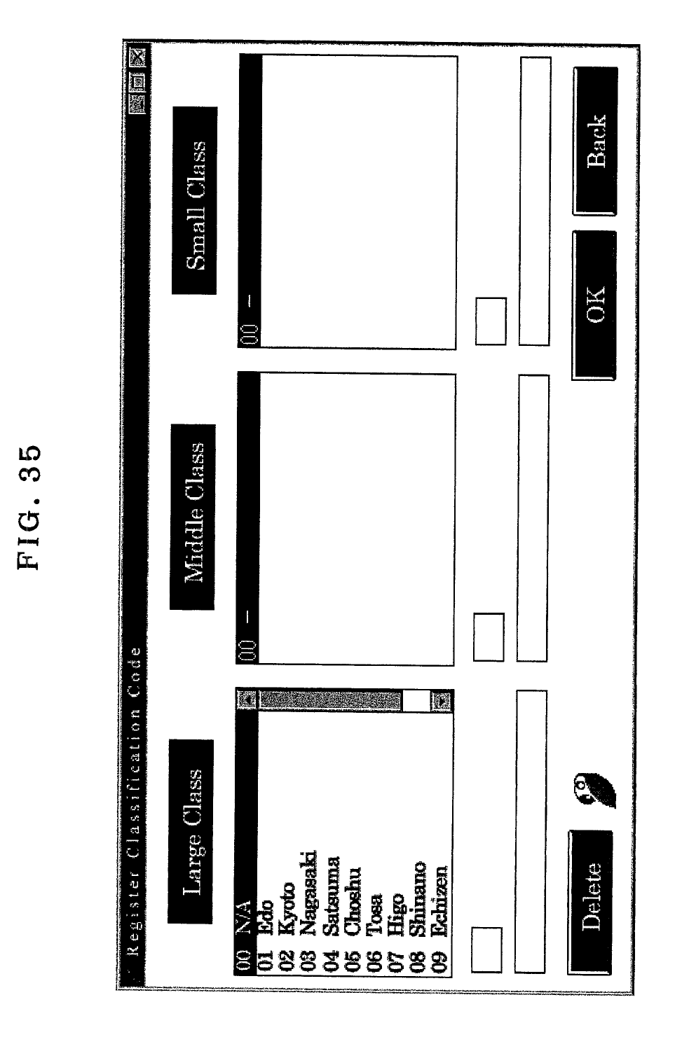

Relationship classification is one of the menus, which appear when the “basic setting” button of FIG. 31 is pressed. This relationship classification plays a role of a “hand” to connect the registered members. This is provided for the purpose of designating in which relationship the members are connected with each other when associating a person with another person. It is possible to put priority rank to the relationship, ranging from deep connection to a mere acquaintance by sight. An example is shown in FIG. 35.

Because this is a code to indicate connection between the two data, it is also possible to designate a plurality of individual data as the same data.

For instance, it is a routine event such as change of family name due to marriage or change of name of a company or a group. As in these cases, it is often much easier to identify the situation of the member if the details at the time of the former name and the details at the time of the new name are both maintained.

In the system of the present embodiment, the relationship of “the person himself or herself” is used as an established initial code in the relationship classification.

In case of a general customer management software, the data must be gathered together as a single data and registered. In the system of the present embodiment, if the data are associated with each other as “the person himself or herself”, there is no need to unify the data. Uncertain data or the data erroneously registered by overlapping will not be overlooked if the data are associated with each other as “the person himself or herself”.

When the data of the members themselves to be connected as “the person himself or herself” are connected, one of them is connected to the main data, and the other is connected to a slave data as the relative of the first degree. In case it is difficult to judge which data is the master data, a code meaning “overlapping data” is provided in the box, and it is designated in the box column of the slave data to facilitate the identification.

Also, when it is wanted to avoid overlapping the number of items of statistical data, if a classification of “overlapping data” is provided in the area code and it is designated to the area of the slave data, then the number of non-related or unnecessary items is counted in the area of the slave data.

Because it concerns in human relationship, not only an information of intimacy but also a relationship of a cat-and-dog life may be registered. It would be very useful if a relationship requiring special attention such as the relationship that a member does not wish to attend the same meeting with a certain person or the relationship that a member does not wish to speak about him before other people is included. Even when the relationship is interrupted because the related member has been transferred or retired from the company, a new relationship may be established, and it is preferable that the relationship is maintained without deleting.

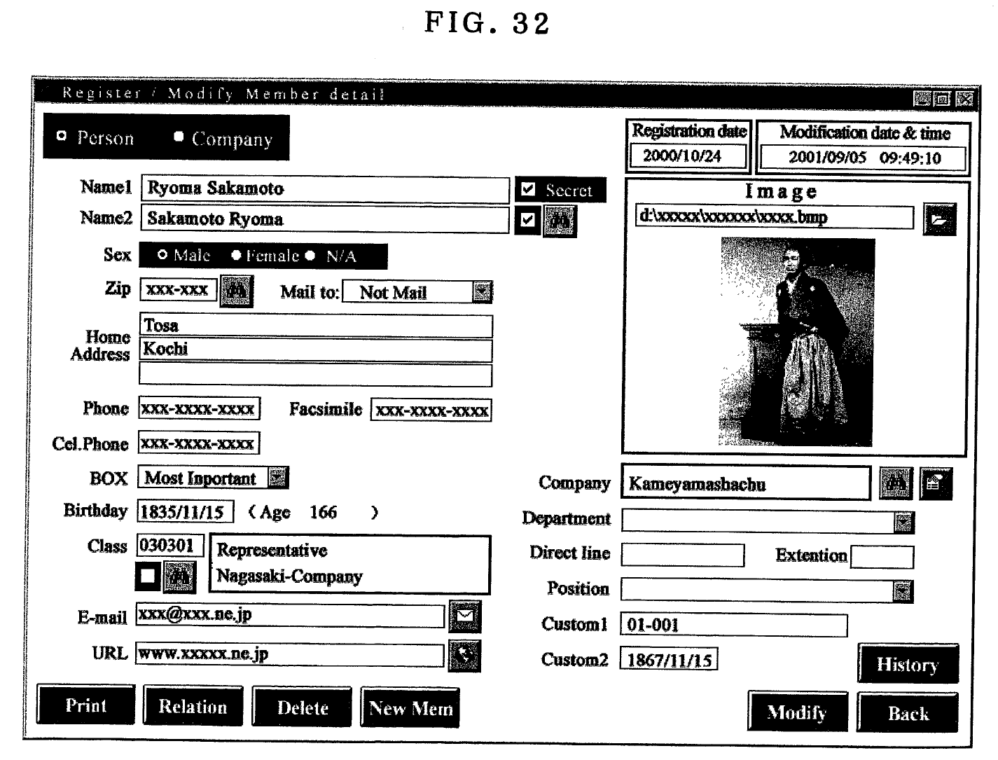

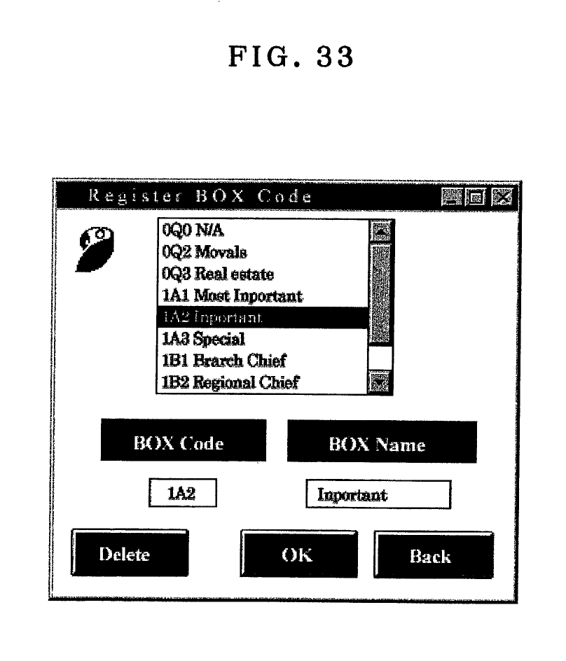

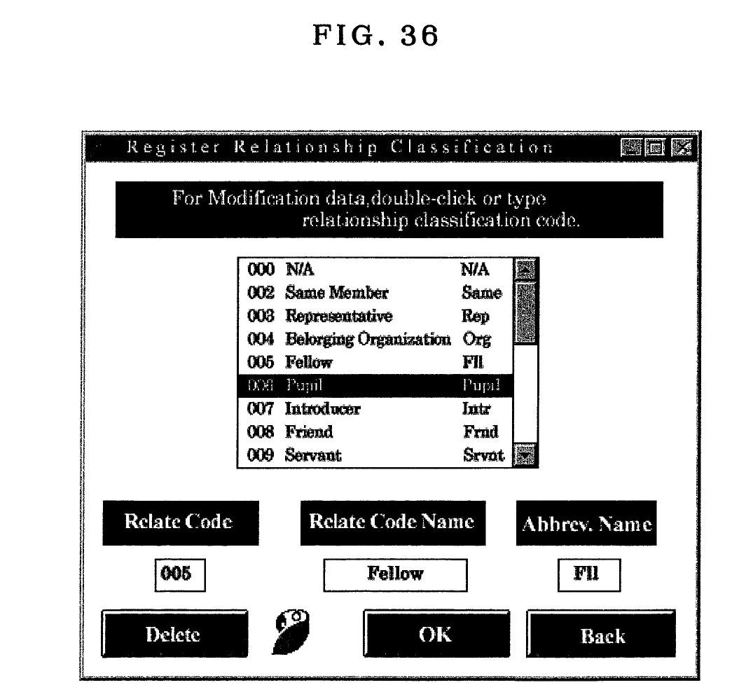

Next, description will be given on the relationship input. When the button “relationship input” shown in the lower part of FIG. 32 is pressed, a relationship input screen as shown in FIG. 36 appears.

Here, the connection between the members themselves and the details of the connection are set. Not only the fact that Mr. A is connected with Mr. B, but also, connection is made from which person to another person, i.e. the detailed relationship is designated.

To indicate the connections which are made from which member to which member, a principal member is regarded as a parent, and a slave member is regarded as a child. A pattern to indicate with relationship exists with the child when seen from parent should be registered in advance in the relationship classification as described above.

On the upper part of the screen of FIG. 36, a member selected by member specifying retrieval, i.e. the preceding processing of the screen, (the standard member) is displayed. On the lower half of the screen, a list of candidates to be associated with the member is given. Between these parts, there are provided a parent-child switchover and a list box to indicate the master-slave relationship. On the parent-child switchover, it is set which of the master and the slave should be designated as parent (master). The relationship classification is displayed in the list box, and the relationship from the parent is selected.

i) “Relationship” Display Button

To display a member, who is associated with the first degree relative of the member in question. To use at the time of referral/change/deletion of the present association.

To select a person, who should be changed in relationship or deleted from the list.

ii) Relationship Updating/Deletion Button

In case of the change, the relationship details are changed and the “relationship updating” button is clicked.

When the relationship is to be deleted, “deletion” button is clicked.

The deletion of the relationship does not mean the deletion of the data itself, but it means the deletion of the connection. Even when the relationship is deleted, the data is maintained. However, if the relationship is deleted, the same members do not appear in the same pedigree unless there is connection between them in a different route.

It is important not to delete to the utmost extent because the relationship of a cat-and-dog relation or breaking-off the relationship should also be regarded as a type of human relationship.

Next, description will be given on the pedigree display, which is the feature of the present embodiment.

In the system of the present embodiment, there are two types of pedigree display systems.

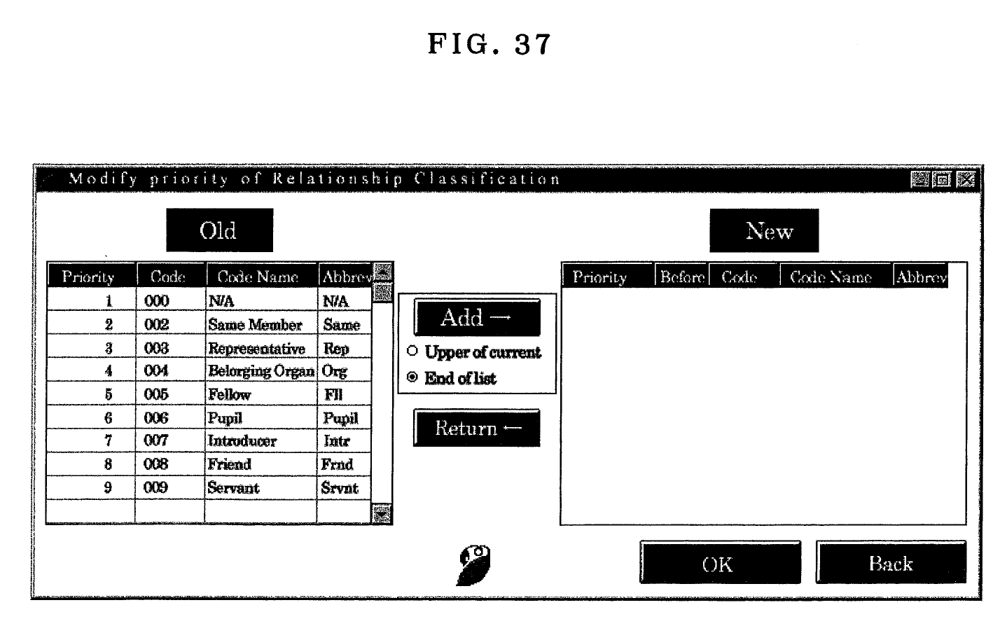

One is “member introduction pedigree (parent-child-grandchild)” shown in FIG. 37. With the person used as reference positioned at the center, parents, children and grandchildren are displayed.

In this pedigree display, the button “change of reference person” is clicked and the reference person is shifted to parents, children and grandchildren on display. By changing the person at the center in the pedigree, all related persons who are connected to the member are displayed one after another.

If all registered members are associated without interruption, these are displayed without interruption. However, if the groups of association are different, the connection will not be continuous in the pedigree even when the reference person is shifted.

In such case, if a member of a different group is selected and this is entered in the pedigree display, the related persons are displayed one after another as described above.

In the database, small groups are formed one after another and continuously grow little by little.

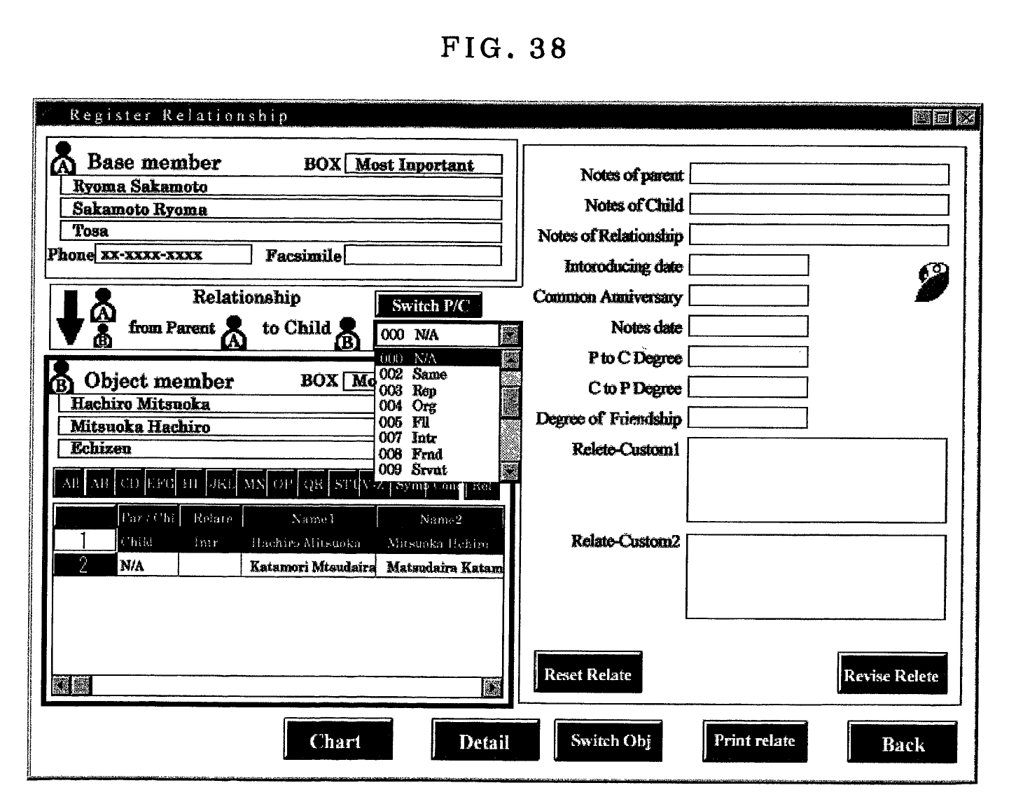

In the display mode of this pedigree, only a limited number of members are displayed as shown in FIG. 38.

Only parents, children and grandchildren of direct line are displayed. A person A connected from the parent in a different line and a person B connected from the child in a different line and those connected with these in direct line can be displayed when the reference person is changed.

The outline of the procedure for retrieval processing of the “member introduction pedigree (parent-child-grandchild)” is as follows:

(1) The code of the member selected from the member list extracted by designating a specific condition is used as a reference person code (“right person CIF”).

(2) Based on the right person CIF, the information of the reference person is acquired from the member management table, and this is stored in a reference person display area.

(3) Based on the right person CIF, the codes of all members in the parent relationship with the reference person (“parent CIF”) and its classification are extracted from the relationship management table, and each information is acquired from the member management table, and priority rank of the classification is acquired from the classification table. From the member with higher priority rank, the information is stored in the parent member list display area.

(4) Based on the right person CIF, the codes of all members in child relationship of the reference person (“child CIF”) and its classification are extracted from the relationship management table. Each information is acquired from the member management table and priority rank of classification is acquired from the classification table. From the member having higher priority rank, the information is stored in a child member list display area.

(5) Based on the child CIF at the uppermost part of the child member list display area, codes of all members in child relationship of the child member at the uppermost part of the child member list display area (“grandchild CIF”) and the classification are extracted and each information is acquired from the member management table, and priority rank of classification is acquired from the classification table. From the member with higher priority rank, the information is stored in a grandchild member list display area.

(6) The display area is displayed.

(7) It is judged whether the user has selected a member other than the member at the uppermost part in the child member list display area. If selected, advance to Step (8). If not selected, advance to Step (9).

(8) Based on the selected child CIF, codes of all members in child relationship of the selected child member in the child member list display area (“grandchild CIF”) and classification are extracted from the relationship management table. Each information is acquired from the member management table, and priority rank of classification is acquired from the classification table. From the member with higher priority rank, the information is stored in a grandchild member list display area and it is displayed again.

(9) It is judged whether the reference person change button has been pressed or not. If it has been pressed, advance to Step (10). If not pressed, the processing is terminated.

(10) The code of the member, which the user selected among the parent member list display area, the child member list display area, and grandchild member list display area, is regarded as the right person CIF. Return to Step (2).

In this parent-child-grandchild display screen, only one generation is displayed above the direct line, and only two generations are displayed under the direct line.

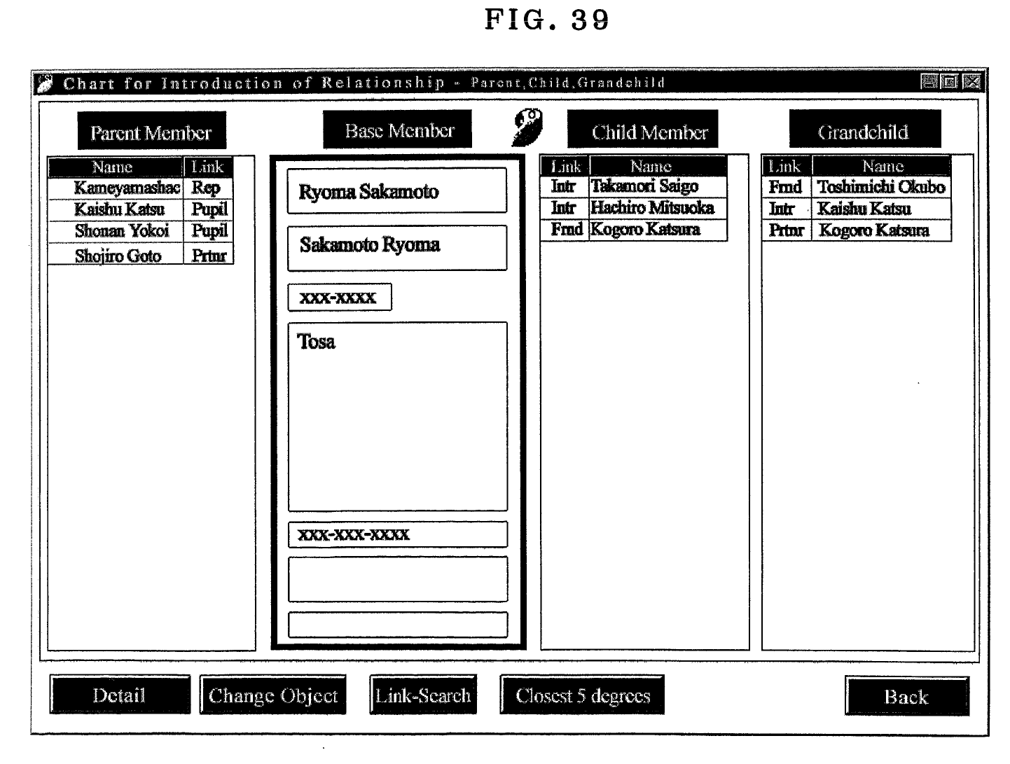

Another pedigree, i.e. “member introduction pedigree (fifth degree relatives before and after)”, is used to compensate the portion not displayed. An example is shown in FIG. 39.

In this “member introduction pedigree (fifth degree relatives before and after)”, all related persons are included in the pedigree within the scope of the five degrees before and after of the reference person determined in the “member introduction pedigree (parent-child-grandchild)” of FIG. 37.

The pedigree showing human relationship as in the system of the present invention cannot be expressed by a one-directional flow, i.e. the parent is at upper position and the child is at lower position as in a family pedigree.

Instead of this, in the system of the present embodiment, a person at the center of the pedigree is displayed at the uppermost left end as shown in FIG. 40. A person of the first degree is displayed at a position lower by one step at left. Similarly, the persons up to the fifth degree are displayed at positions lower by one step each leftward.

Arrows in lateral direction indicate relationship from parent to child. The mark “ . . . ” means that there is the shortest route elsewhere.

For instance, the mark “ . . . ” is attached to “Ryoma Sakamoto” in the column (a). “Ryoma Sakamoto” of (a) is in the second degree as seen from “Kaishu Katsu”. If we look at the other route, “Ryoma Sakamoto” is displayed in (b) of the first degree. Because (b) is closer than (a) to “Kaishu Katsu”, i.e. a reference person, the portion with the mark “ . . . ” is given for reference.

The mark + means that human relationship continues still downward.

In case of human relationship to be concealed or complicated human relationship, the pedigree can be feely rearranged by using this function of +.

The outline of the procedure to generate the member introduction pedigree is as follows:

(1) Based on the reference person CIF, the information of the reference person member in the member management table is acquired, and this is displayed in a tree view area.

(2) Selection of the first degree

(2-1) Based on the code of the reference person (CIF), the parent member is extracted from the relationship management table, and it is additionally displayed under the reference person with one member in one step in second column of the tree view area in the order of priority rank.

(2-2) Based on the reference person CIF, a child member is extracted from the relationship management table, and it is additionally displayed under the parent member with one member in one step in the second column of the tree view area in the order of priority rank.

However, if a member with the same CIF is already displayed in the tree view area, the mark “ . . . ” should be added after the name.

(3) Selection of the second degree

(3-1) For member of the first degree displayed in the second column, the following processing is performed in the order from above.

(3-2) Based on the first degree relative CIF, a parent member is extracted from the relationship management table, and it is inserted and displayed between the corresponding first degree member and the next first degree member with one member in one step in the third column of the tree view area in the order of priority rank.

However, if the member two degrees before (the reference person) in direct line, “selection of the second degree” is not carried out.

(3-3) If the member in the corresponding step of the first degree is with the mark “ . . . ”, “selection of the second degree relative” is not carried out.

(3-4) If members with the same CIF are already displayed in the tree view area, the mark “ . . . ” is attached after the name.

(3-5) Based on the first degree relative CIF, a child member is extracted from the relationship management table, and this is inserted and displayed between the corresponding first degree member and the next first degree member in the third column of the tree view area in the order of priority rank.

However, if the members two degrees before (the reference person) in direct line are the same member, “selection of the second degree relative” is not carried out.

(3-6) If the member in the corresponding step of the first degree has the mark “ . . . ”, “selection of the second degree relative” is not carried out.

(3-7) If a member with the same CIF is already displayed in the tree view area, the mark “ . . . ” is added after the name.

(4) Selection of n-th degree relative (n=3)

(4-1) For the members of the second degree displayed in the third column, the following processing is performed from above.

(4-2) Based on the second degree relative CIF, a parent member is extracted from the relationship management table, and this is inserted and displayed between the corresponding second degree member and the next second degree member with one member in one step in the fourth column of the tree view area in the order of priority rank.

However, if the members two degrees before (the first degree relative) in direct line are the same members, “selection of the third degree relative” is not carried out.

(4-3) If the member in the corresponding step of the second degree has the mark “ . . . ”, “selection of the third degree relative” is not carried out.

(4-4) If a member with the same CIF is already displayed in the tree view area, the mark “ . . . ” is added after the name.

(4-5) Based on the second degree relative CIF, a child member is extracted from the relationship management table, and this is inserted and displayed between the corresponding second degree member and the next second degree member with one member in one step in the fourth column of the tree view area in the order of priority rank.

However, if the members two degrees before (the first degree relative) in direct line is the same member, “selection of the third degree relative” is not carried out.

(4-6) If the member in the corresponding step of the second degree has the mark “ . . . ”, “selection of the third degree relative” is not carried out.

(4-7) If the member with the same CIF is already displayed in the tree view area, the mark “ . . . ” is added after the name.

(5) Subsequently, the same processing is performed for the fourth degree and the fifth degree relatives by progressively increasing the number in Step (4).

Next, description will be given on relationship retrieval function, which is another feature of the present embodiment.

When the “relationship retrieval” button is clicked, a screen of member relationship retrieval shown in FIG. 38 is displayed.

Here, two persons or two organizations are designated, and it is searched whether there is connection between the members. In the upper step, the reference person member is placed. However, it is shifted to the retrieval screen by pressing the “condition retrieval” button, and the members can be changed as desired in both upper step and the lower step.

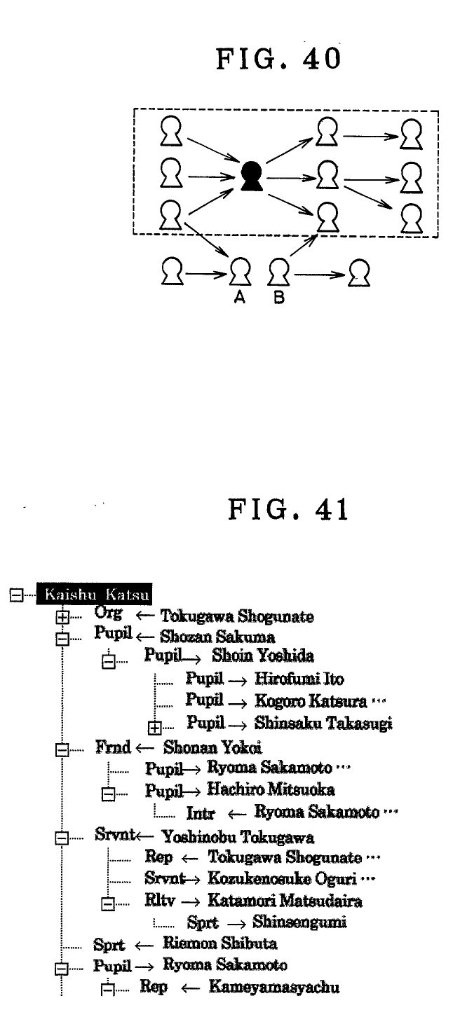

The relationship is traced within the scope from the first degree to the tenth degree. Using the radio button, it is designated whether the shortest route is to be found or all routes are to be found. When the message “display all relationships” is checked and the execution button is clicked, the degree and serial number in the same degree relatives are displayed in the list box at upper left of the pedigree in FIG. 38. FIG. 41 is used to explain this and shows an example of pedigree between two members each on the left side and the right side.

When a route to be referred is selected in the list box, the pedigree of this route is displayed. If “detail” button is clicked, the registration details of the person selected in the pedigree is displayed.

The “printing” button is used to have a preview of the results of tracing on display and to be ready for printing by a printer.

The processing procedure of this relationship retrieval function is as follows:

(1) Among the two members to trace the relationship, one is regarded as a regular member, and the other is regarded as a sub-member. With the purpose of tracing whether the sub-member is connected to the regular member or not, the present condition is stored, and an array area in the memory temporarily storing the retrieval results is initialized. When a canceling button is pressed by the user, the processing should be stopped, and the result up to the middle way stored in the memory is discarded.

(2) Before performing the processing, the setting condition is stored, i.e. to which degree the searching is made at the most and whether the shortest route or all routes should be searched as designated by the user. Here, explanation is given on a case where all members up to the fourth degree are searched.

(3) The first degree member in parent-child relation of the regular member is extracted.

(3-1) Among the number of records “na” in the first A degree as extracted, it is judged whether ia-th (i=1 to n) is a sub-member or not.

(3-1-1) If it is a sub-member, the route from the regular member is stored in the array area of the memory and the processing of the step (3-1) is carried out to the record of the next first degree relative.

(4) If it is not a sub-member, the second degree member in parent-child relation of ia-th member of the first degree is extracted.

(4-1) Among the number of records “nb” in the second degree thus extracted, it is judged whether ib-th (i=1 to n) member is a sub-member or not.

(4-1-1) If it is a sub-member, the route from the regular member is stored in array area of the memory, and the processing of Step (4-1) is carried out to the record of the next second degree.

(4-2) If it is not a sub-member, it is judged whether the same member as ib-th member of the second degree is present at higher position in the route or not.

(4-2-1) If it is present at such position, the processing is interrupted, and the processing of Step (4-1) is carried out to the record of the next second degree.

(5) If it is not present at such position, the third degree member in parent-child relation of ib-th member of the second degree is extracted.

(5-1) Among the number of records “nc” of the third degree thus extracted, it is judged that ic-th member (i=1 to n) is a sub-member or not.

(5-1-1) If it is a sub-member, the route from the regular member is stored in array area of the memory, and the processing of Step (5-1) is carried out to the record of the next third degree.

(5-2) If it is not a sub-member, it is judged whether the same member as ic-th member of the third degree is present at higher position in the route or not.

(5-2-1) If it is present at such position, the processing is interrupted, and the processing of Step (5-1) is carried out to the record of the next third degree.

(6) If it is not present at such position, the fourth degree member in parent-child relation of ic-th member of the third degree is extracted.

(7) Among the number of record “nd” of the fourth degree thus extracted, it is judged whether id-th (i=1 to n) member is a sub-member or not.

(7-1-1) If it is a sub-member, the route from the regular member is stored in array area in the memory, and it is advanced to the next record of the fourth degree.

(7-2) If it is not a sub-member, it is advanced to the next record of the fourth degree. If the record of the fourth degree is completed to n-th member, the number of records of the third degree is progressively advanced by one, and the processing is performed.

(7-3) If the number of records of the third degree is completed up to “n”, the number of records of the second degree is progressively increased by one, and the processing is performed.

(7-4) When the number of the records of the second degree is completed to “n”, the number of records of the first degree is progressively increased by one, and the processing is carried out.

(8) The results of the retrieval stored in the array area in the memory is rearranged from the member having number of the degree in the route.

(9) The first of the retrieval results is displayed in the tree view.

(10) When the user designates the change of the retrieval result displayed in the pulldown list box, a route selected by the user in the retrieval result is displayed in the tree view.

As described above, the following effects can be obtained by the present embodiment:

1. A pedigree of human relationship can be expressed on 2-dimensional paper.

2. Even when the same person may appear many times in the pedigree (even when the circulation occurs), it is possible to search the related route in reliable manner.

3. The connection can be expressed in parent-child relation. The relationship can be differentiated, and the depth of the connection can be differentiated.

4. Because the pedigree is expressed, not by generation but by degree of relatives, it is possible to trace the relationship freely and to display in a tree structure without fixing the direction of connection from parent direction and child direction.

5. The pedigree can be continuously prepared so far as the relationship exists.

6. It is possible to trace the connection of any two members as desired in all of the routes.

In the embodiments described above, it is designed in such manner that relationship information entangled in complicated manner is partially highlighted and is checked and evaluated by displacing slightly, and relationship pedigree can be indicated in simple manner. By this arrangement, it is possible to watch and assess the connection of the central data with the data setting out from it. In this arrangement, however, it is not possible to trace the changes of combination and separation over time and to evaluate the change of the relationship. In the relationship management table, parents and children are associated with each other while parents and children are not necessarily positioned in the order of generating or originating. Parents and children are set and positioned for the convenience of the user. Therefore, when parent and child are associated with each other, it is not possible to set the relationship in reverse direction or to set a plurality of relationships at the same time. This is because a relationship perpetually circulating is made up when the relationship is retrieved and traced unless parent-child relationship is set in one direction to trace the association.

Next, a relationship vector table is further added to the above embodiment. In this new embodiment, it is possible to retrieve and trace the relationship in terms of position and time by means of a “retroactive route” through simultaneous use of the relationship management table. This is needed, for instance, in the following cases:

In the above embodiment, when related human connection is inputted, and if the name is changed, it is not possible to trace back to the root even when connection is made through the relation of the person in question because there is no order of generating. The order of generating may be found in each of the data, but it is difficult to reflect the display made in the order to the pedigree. For this purpose, the relationship information must have a direction, which is suitable for each case and which is a direction of parent-child relationship different from the time of generation.

Now, taking an example in the creation or the generation of the universe, the phenomena repeatedly occur due to “big bang” as separation of a certain substance A at a certain time and at a certain position. Further, it is separated to substances B and C at a certain time at a certain position, and the substance A is changed to a substance A′. When such combination and separation repeatedly occur, there may be the case where the original substance is turned to a different substance specific to itself or the case where the substance is changed while retaining the original attribute as before. When the relationship information is used in the field of science, there is a risk that a substance separated and combined by the same phenomenon may be regarded as the same substance as before unless information is available for the time and the position to make up the relationship. It would be all right if it is limited to such simple relationship as human relationship, in which the importance is not given as to where two persons became acquainted with each other. However, the information of the change of substance or segmentation or division of microorganism is an information, for which time and position are indispensable. By tracing back time and position of the relationship information in terms of time and position, it is possible to trace the transition of the data.

Further, the information relating to the persons who participated in propagation of information is to be recorded to trace back the source of information, from which rumor might have spread. The rumor may sometimes spread and may be propagated to the same person by more than once, e.g. A→B→C→ . . . →A→B→b→G→ . . . →B→A→ . . . . In this case, what was informed at the second time may often be different from what was heard at the first time. If we consider the connection of the relationship, the first relationship between A and B is exactly the same as the second relationship between A and B. The third relationship (i.e. from B to A) is different in that only the direction of information propagation is reversed. However, the time of information propagation is different, and this may exert influence on the change of information, for instance, depending on the position of propagation. The data such as time and position as described above should be included in the information of each individual person and the data should be processed as these are included in the relationship information.

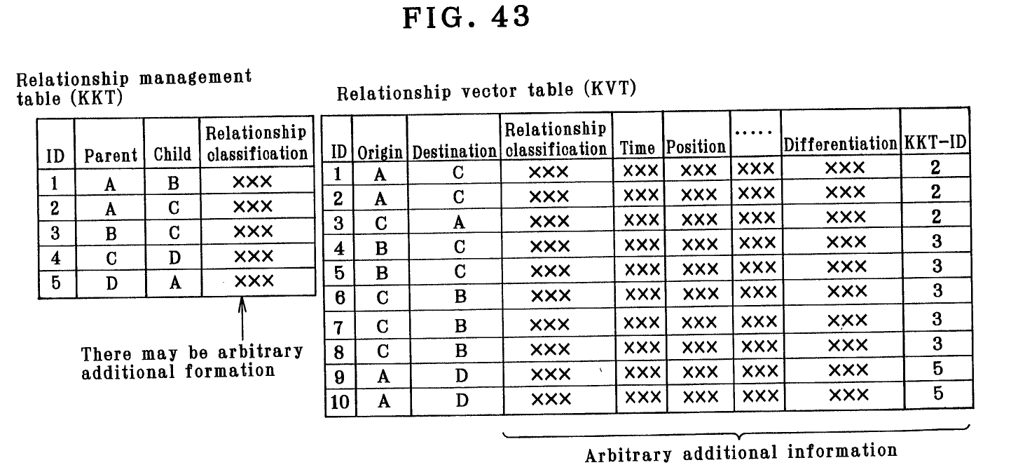

As described above, when handling the relationship information, it is very advantageous to identify “the retroactive route”. In this respect, for the purpose of manipulating this “retroactive route”, a relationship vector table KVT is added to the relationship management table KKT as a data table shown in FIG. 43.

In FIG. 43, the relationship management table KKT is the same as before, but relationship classification is not included in it and this may be included in the relationship vector table KVT. Also, detailed portion of each data may be preserved in a member management table (not shown). As already explained, in the relationship management table KKT, a direction of tracing the relationship between the two is determined through parent-child relationship. In reality, it plays a role as orientation means to exclude perpetual circulation in the course of processing such as retrieval, tracing, etc. For this reason, parent-child relationship between the two is not registered repeatedly and it is a specific relationship, and parent and child are never recorded in reverse direction.

In the relationship vector table KVT, unlike the parent-child relationship in the relationship management table KKT, the relationship between the two is registered by more than one time together with the direction and the position in time series, connecting position, and order of connecting. In the processing based on the assumption that the data are written in the relationship vector table KVT, the data are recorded one by one for all relations associated with each other, and the direction of relationship is indicated, not by parent and child, but by origin and destination. The origin and the destination can be specified regardless of the setting of parent and child. In each record in the relationship vector table KVT, additional information is given, i.e. an information that an aggregate specified individually and sequentially is registered as a group or that rank is set for linking, and the data is recognized as a unique record. The relationship vector table KVT is needed in case a plurality of relations apparently appear or in case there is ranking in the relation. However, when it would suffice if only the relationship can be found, it is desirable to design in such manner that it can be selected whether or not the information is to be written in the relationship vector table KVT depending on the need of the user because memory region may be packed otherwise.

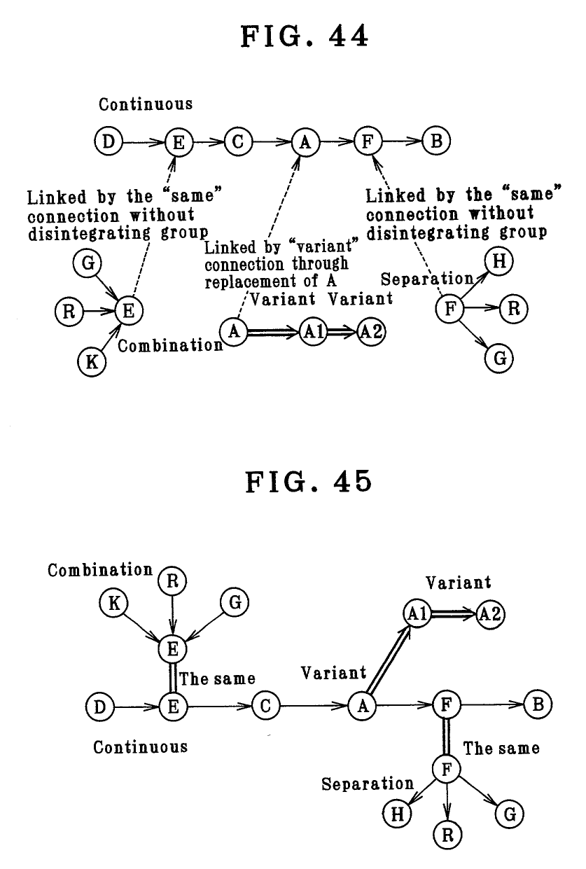

In the relationship vector table KVT, when the relations are connected on one-to-one basis, on multiple-to-one basis, or on multiple-to-multiple basis, arbitrary additional information may be given as shown in FIG. 44, and it may be designed in such manner that the user can freely set connecting position and connecting sequence with differentiation classification such as “the same”, “replacement”, “variant”, “continuous”, “combination”, or “separation”. In the classification “the same”, two data are regarded as the same but these are not integrated, and linking is made without changing the original shape of group, i.e. this is the same concept as the relationship classification of “the person in question”. In the classification “replacement”, two data are regarded as the same data, and one of them is indicated as a data with priority. The other data, i.e. non-priority data is regarded as concealed data or collected data, and these are integrated as a unity. In the classification “variant”, it is considered that the data has been changed from original data to destination data, and these are linked by clearly defining the distinction of the new and the old. In the classification “continuous”, it is considered that the original data is continuous to the destination data, and linking is made by clearly defining the distinction of the new and the old. In the classification “combination”, linking is made on multiple-to-one basis. In the classification “separation”, linking is made on one-to-multiple basis. Also, in case it is necessary to perform definite association in time series at the intention of the user, it should be specified by which member of which group the relations already classified in groups are linked as shown in FIG. 45.

By the use of the relationship vector table KVT, it is possible to simultaneously use the reference object center display (hereinafter, also referred as “relationship pedigree”) and the position time series display (hereinafter also referred as “relationship map” or “relationship chronological table”). For instance, when association is made on one-to-one basis as shown in FIG. 44, apart from the reference object center display made up on relationship network when linking while even the user is not aware, the association based on the intention of the user is directly displayed as shown in FIG. 45 in the position time series display. By simultaneously using these, it is possible to prepare relationship map or relationship chronological table of the data, and reference object center display of an arbitrary data specified therein can be used.

In the relationship management table KKT, the relationship linked in parallel or linked in series as described above, and the relationship classified as groups are disassembled as a connection specific to one-to-one association and are registered, and the same relationship or reverse relationship is not recorded. Specifically, when relationship is expressed only in the relationship management table KKT, parent-child relationship is used in common to indicate the relationship and flow of relationship tracing. When there are more than one relationship patterns between the two or when there is a relationship such as A→B and, at the same time, B→A, there has been no other way but to register only one of them.

For instance, it is supposed here that A is a senior staff of B and that A and B both belong to the same circle. Also, it is supposed that B was a senior student in school to A and was a former teacher to A. In this case, the initial relationship is B→A (junior to senior). Then, it was turned to A=B (i.e. companions in the circle). Later, the relationship A→B (senior) was established. Finally, the relation B→A (former teacher) was made up. In this case, the relationship cannot be expressed only by parent-child relationship of the relationship management table KKT. Therefore, the relationship in each case, and direction and time series information are recorded in the relationship vector table KVT. In the concept of the relationship vector table KVT in this case, the table is prepared under the assumption that the relationship information registered in it is specific by itself, and there is no relationship of the same attribute between arbitrary two partners. Therefore, in case the user wishes to give a meaning of more than one relations in the same relationship, the user wants intentionally to specify the order of the relations or the reverse relationship should be retained. Such information is given to the relationship vector table KVT so that each of the records such as time information, position information, etc. has different relationship.

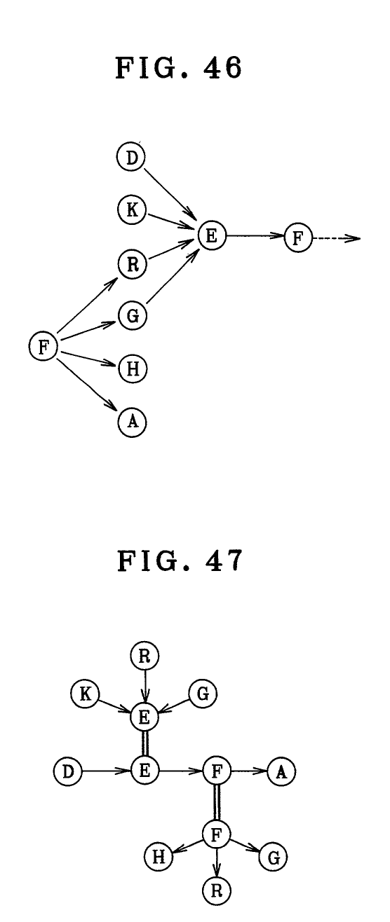

In so doing, when the connection is expressed by chains, even when the same relationship may appear at more than one time points, “retroactive route” can be displayed as a different one. However, in this display, the position to display reference object is not specific, and it is not possible to see all related persons at one time. For instance, FIG. 46 is a figure, which is prepared by replacing the relationship map in FIG. 47 by a relationship pedigree. If it is disassembled and thoroughly investigated, these are the figures relating to the same relationship. In FIG. 46, the relationship as seen from each individual can be understood at a glance. In FIG. 47, the transition of the relationship is indicated in more intelligible manner. However, while G in the lower portion of FIG. 47 is being referred, it is not possible to find the connection with E.

In this respect, a relationship pedigree with G as a reference object can be displayed while referring to G. And it is possible to refer at which point on the relationship map a different member indicated to have connection is displayed. Further, if it is possible to see the other connection when it is moved to the other position, even the difference of time and position can be identified at the same time.

For instance, when the data to be investigated are dispersed at more than one points on the relationship map (or on the relationship chronological table) and there are more than one destinations to move to, it may be arranged in such manner that positions and attributes of these data are indicated by means such as list box and the user may select the object displayed or the related data may be displayed with high luminance on the relationship map to facilitate the position identification. When it is moved to the selected position, it is desirable to arrange that the data is automatically displayed by scrolling on the designated position of the relationship map using means such as jump button. In this way, if it is possible to refer to the relationship pedigree at the desired spot on the relationship map and to move to it, a system can be built up, in which the relationship can be identified in easier manner.

In arbitrary additional information, the time is not limited to the units such as year, month, day, hour, minute or second, but an attribute to express process of the change of information may be used. By the use of expression such as position and time, the position can be expressed in 3-dimensional space, and time may have an effect as 4-dimensional meaning to express the process of change. Even when the time may be the same, the relationship between A and B is an ordinary relationship when it is seen from C. But, if it is seen from D, it may look as a relationship at odds. When it is seen from E, it may look as the relationship of a happy married couple. In this respect, subjective view of those who register the data gives strong influence on the association. When there are indefinite number of users in a system, the information that the person who inputted the data is a different person may be regarded as a position information.

Further, there may be additional information to recognize that more than one relations existing between the same two persons such as speed, force, etc. are specific by themselves. If there is an area with arbitrary additional information in the relationship vector table KVT, such information can be arranged without regard to the developer and the user of the system.

Also, the prepared aggregates are registered with names as group members such as “aggregate-single unit,”, “single unit-aggregate”, or “aggregate-aggregate” and a relationship map may be prepared. In so doing, it is possible to identify the connection for each of the aggregates and connection of the single unit member which make up the aggregate. Further, it is possible to retrieve the aggregate, which includes a specific type of chain relationship. For instance, in the field of scientific study, such as a study on multimolecular compound having any desired molecular structure, a study to trace generation and transition of a subject such as language, or a research field to study celestial bodies, i.e. constellation and nebulae, fixed stars and planets.

What is claimed is:

1. An associating information management system for associating various types of information and for managing the information, said system comprising:
a relationship management table for storing parent-child relationship in identification information of each type of information; and
retrieval processing means for performing retrieval processing of various types of information from parent to child and from child to parent by association of the relationship management table in the information and the scope as designated.

2. An associating information management system according to claim 1, wherein said various types of information are managed by a member management table where member data comprising said identification information and detailed information are stored.

3. An associating information management system according to claim 2, wherein said detailed information comprises a classification information for classifying the members.

4. An associating information management system according to claim 3, wherein said classification information comprises type, rank, classification, and job type.

5. An associating information management system according to claim 2, wherein said detailed information comprises various types of information including FAT information, address recorded in FAT, file type, directory pass, file name, scope of selection, object, attribute and information having attribute.

6. An associating information management system according to claim 1, wherein said identification information comprises ID, FAT information, address recorded in FAT, file type, directory pass, file name, scope of selection, object, attribute, or information having attribute.

7. An associating information management system according to claim 1, wherein said relationship management table comprises information of mutual associating direction and degree of relationship.

8. An associating information management system for managing by associating various types of information, said system comprising:
a relationship management table for storing parent-child relationship in identification information of each information;
a member management table for storing said identification information and said various type of information;
input processing means for performing input, setting and indication of the data;
associating information management means for retrieving various types of information from parent to child and from child to parent by association of the relationship management table in the information and the scope as designated by said input processing means and for processing various types of information stored in the member management table; and
output processing means for performing output processing of the data processed by said associating information management means.

9. An associating information management system according to claim 8, wherein said input processing means associates one or a plurality of data stored in said member management table with one or a plurality of different types of data under a given condition, and stores the result of the association in said relationship management table.

10. A program for associating information management for associating and managing various types of information by using a relationship management table for storing the result of said association of parent-child relationship in identification information of various types of information, whereby there are provided a function to carry out retrieval of various types of information from parent to child by the association of the relationship management table and a function to perform retrieval of various types of information from child to parent.

11. A program for associating information management for associating and managing various types of information by using a relationship management table for storing the result of said association of parent-child relationship in identification information of various types of information, whereby the program carries out a function to select one or a plurality of parents or one or a plurality of children under a selection condition as designated by said various types of information, a function to associate said selected one or a plurality of parents and said one or a plurality of children by said identification information and to store in the relationship management table, a function to retrieve various types of information from parent to child by association of the relationship management table, and a function to retrieve various types of information from child to parent.

12. A recording medium for associating information management to associate and manage various types of information, said recording medium being able to read the data by computer and used to record at least:
a relationship management table for storing association of parent-child relationship in identification information of various types of information; and
a retrieval processing program for performing retrieval processing of various types of information from parent to child and from child to parent by association of the relationship management table in the designated information and scope.

13. A recording medium for associating information management to manage various types of information by associating, said recording medium being able to read by computer and at least comprising:
a relationship management table for storing association of parent-child relationship by identification information of various types of information;
a member management table for storing said identification information and said various types of information;
an input processing program for inputting, setting, and indicating the data;
an associating information management program for retrieving various types of information from parent to child and from child to parent by association of said relationship management table in said designated information and scope and for processing various types of information stored in said member management table; and
an output processing program for performing output processing of the data processed by said associating information management program.

14. An associating information management system provided with database, said database comprising;
a member management table for storing member information of individuals and organizations including name or organization name, address, telephone number, etc.; and
a relationship management table for defining relationship between a member registered in the member management table and another member related to said member by parent-child relationship and for entering classification code to indicate type of relationship and priority rank of the relationship.

15. An associating information management system according to claim 14, wherein there is provided a classification table for defining which relationship the classification code indicates and which priority rank the classification code indicates in addition to the relationship management table.

16. An associating information management system according to claim 14 or claim 15, wherein there is provided an area code for statistical data preparation and for classification and assignment of the registered member in the registration items in the member management table.

17. An associating information management system, comprising:
a member management table for storing member information of individuals and organizations including name or organization name, address, telephone number, etc.;
said system records relationship record defining relationship between a member registered in the member management table and another member relating to said member by parent-child relationship, said system being provided with a database, which comprises a relationship management table for recording classification code indicating type of the relationship and priority rank of the relationship, and when the member is designated as a reference person, a member in parent-child relationship with said member is extracted and displays parent member, child member and grandchild member together with the reference person as a list, said system further comprising means for executing the following steps of:
(1) making a code of a member selected in a member list extracted by designating a specific condition as a reference person code (“reference person CIF”);
(2) acquiring information of the reference person from the member management table based on the reference person CIF and of storing the information in a reference person display area;
(3) extracting codes of all members in parent relationship of the reference person from the relationship management table (“parent CIF”) and classification thereof based on the reference person CIF, acquiring each information from the member management table and priority rank of classification from the classification table, and storing the information in a parent member list display area from a member with higher priority rank;
(4) extracting codes of all members in child relationship of the reference person from the relationship management table (“child CIF”) and classification thereof based on the reference person CIF, acquiring each information from the member management table and priority rank of classification from the classification table, and storing the information in a child member list display area from a member with higher priority rank;
(5) extracting codes of all members in child relationship of a child member at the uppermost part of the child member list display area (“grandchild CIF”) from the relationship management table based on a child CIF at the uppermost part of the child member list display area and classification thereof, acquiring each information from the member management table and priority rank of classification from the classification table, and storing the information in a grandchild member list display area from a member with higher priority rank;
(6) displaying the display area;
(7) judging whether or not the user has selected a member other than the uppermost member in the child member list display area (If selected, advance to Step (8). If not selected, advance to Step (9));
(8) extracting codes of all members in child relationship of a child member selected in the child member list display area and classification thereof from the relationship management table based on the selected child CIF, acquiring each information from the member management table, and priority rank of classification from the classification table, and storing and displaying again the information in a grandchild member list display area from a member with higher priority rank;
(9) judging whether a reference person change button is pressed or not (If pressed, advance to Step (10). If not pressed, wait for the next instruction.); and
(10) making a code of a member as a reference person CIF who was selected by the user from each of the parent member list display area, the child member list display area, and the grandchild member list display area (Return to Step (2).).

18. An associating information management system, comprising:
a member management table for storing member information of individuals and organizations including name or organization name, address, telephone number, etc.;
said system records relationship record defining relationship between a member registered in the member management table and another member relating to said member by parent-child relationship, said system being provided with a database, which comprises a relationship management table for recording classification code indicating type of the relationship and priority rank of the relationship, and a member in parent-child relationship is extracted by a member code set in the reference person, and degrees of relatives are displayed in a tree view in the order of relatives of closer degree, said system further comprising means for executing the steps of:
(1) acquiring information of the reference person member of the member management table based on the reference person CIF, and displaying the information in a tree view area;
(2) selection of the first degree relatives
(2-1) extracting a parent member from the relationship management table based on the reference person CIF, and additionally displaying the information under the reference person with one member in one step in the second column of the tree view area in the order of priority rank;
(2-2) extracting a child member from the relationship management table based on the reference person CIF, and additionally displaying the information under the parent member with one member in one step in the second column of the tree view area in the order of priority rank, whereby an abbreviation symbol is added after the name if a member with the same CIF is already displayed in the tree view;
(3) selection of the second degree relatives;
(3-1) performing the following processing in the order from higher position on members of the first degree displayed in the second column:
(3-2) extracting a parent member from the relationship management table based on the first degree relative CIF, and inserting and displaying the information between the corresponding first degree member and the next first degree member with one member in one step in the third column of the tree view area in the order of priority rank, whereby “selection of the second degree relatives” is not carried out if the member of two degrees before (the reference person) in direct line is the same member;
(3-3) “selection of the second degree relatives” is not carried out if an abbreviation symbol is attached to a member in the corresponding step of the first degree;
(3-4) adding an abbreviation symbol after the name if a member with the same CIF is already displayed in the tree view;
(3-5) extracting a child member from the relationship management table based on the first degree relative CIF, and inserting and displaying the information between the corresponding first degree member and the next first degree member with one member in one step in the third column of the tree view area in the order of priority rank, whereby “selection of the second degree relatives” is not carried out if the member of two degrees before (the reference person) in direct line is the same member;
(3-6) “selection of the second degree relatives” is not carried out if an abbreviation symbol is attached to a member of the corresponding step of the first degree;
(3-7) adding an abbreviation symbol after the name if a member with the same CIF is already displayed in the tree view area;
(4) selection of n-th degree relatives (n=3)
(4-1) performing the following processing respectively in the order from higher position on n−1-th degree member displayed in n-th column;
(4-2) extracting a parent member from the relationship management table based on n−1-th degree relative CIF, and inserting and displaying the information between the member of the corresponding n−1-th degree and the next n−1-th degree member with one member in one step in n+1-th column of the tree view area in the order of priority rank, whereby “selection of n-th degree relatives” is not carried out if a member of two degrees before (n−2-th degree relative) in direct line is the same member;
(4-3) “selection of n-th degree relative” is not carried out if an abbreviation symbol is attached to a member of the corresponding step of n−1-th degree;
(4-4) adding an abbreviation symbol after the name if a member with the same CIF is already displayed in the tree view area;
(4-5) extracting a child member from the relationship management table based on n−1-th degree relative CIF, and inserting and displaying the information between the corresponding n−1-th degree member and the next n−1-th degree member with one member in one step in n+1-th column of the tree view area in the order of priority rank, whereby “selection of n-th degree relative” is not carried out if a member of two degrees before (n−2-th degree relative) in direct line is the same member;
(4-6) (selection of n-th degree relative) is not carried out if an abbreviation symbol is attached to a member in the corresponding step of n−1-th degree;
(4-7) adding an abbreviation symbol after the name if a member with the same CIF is already displayed in the tree view area;
repeating Step (4) until “n” reaches a predetermined number by progressively increasing “n” by one in Step (4) after the procedure of (5) above, and completing the processing if “n” reaches the predetermined number.

19. An associating information management system, comprising:
a member management table for storing member information of individuals and organizations including name or organization name, address, telephone number, etc.;
said system records relationship record defining relationship between a member registered in the member management table and another member relating to said member by parent-child relationship, said system being provided with a database, which comprises a relationship management table for recording classification code indicating type of the relationship and priority rank of the relationship, and said system extracts up to any degree of relative as desired and displays whether a relationship route is made up using member codes of two members as set to the reference person, said system further comprising means for executing the steps of:
(1) setting one of the two members for tracing the relationship as a regular member, and the other as a sub-member, storing a setting condition to trace whether the sub-member is connected with the regular member, and initializing array area in the memory for temporarily storing retrieval result;
(2) storing the setting condition as to up to which degree should be searched at the furthest or whether the shortest route should be searched or all routes should be searched as designated by the user when processing is performed;
(3) extracting the first degree member in parent-child relationship of the regular member;
(3-1) judging whether ia-th (i=1 to n) member is a sub-member or not among the number of records “na” of the extracted first degree member;
(3-1-1) if it is a sub-member, executing the processing of Step (3-1) to the record of the next first degree member by storing the route from the regular member in array area of the memory;
(4) if it is not a sub-member, extracting the second degree member in parent-child relationship of ia-th member of the first degree;
(4-1) judging whether ib-th (i=1 to n) member is a sub-member or not among the number of records “nb” of the second degree extracted;
(4-1-1) if it is a sub-member, executing the processing of Step (4-1) to the record of the next second degree by storing the route from the regular member in array area of the memory;
(4-2) if it is not a sub-member, judging whether the same member as ib-th member of the second degree is present at higher position in the route or not;
(4-2-1) if it is present at higher position, executing the processing of Step (4-1) to the record of the next second degree member by interrupting the processing;
(5) if it is not present at higher position, extracting the third degree member in parent-child relationship of ib-th member of the second degree;
(5-1) judging whether ic-th (i=1 to n) member is a sub-member or not among the number of records “nc” of the third degree extracted;
(5-1-1) if it is a sub-member, executing the processing of Step (5-1) to the record of the next third degree member by storing the route from the regular member in array area of the memory;
(5-2) if it is not a sub-member, judging whether the same member as ic-th member of the third degree is not present at higher position in the route or not;
(5-2-1) if it is present at higher position, interrupting the processing and executing the processing of Step (5-1) to the record of the next third degree member by interrupting the processing;
(6) if it not present at higher position, extracting the fourth degree member in parent-child relationship of ic-th member of the third degree;
(7) repeating the procedure by progressively increasing the value up to the degree of the number as set in advance, and performing the following processing in the final degree member:
(7-1) judging whether ix-th (i=1 to n) member is a sub-member or not among the number of records “nx” of the final degree extracted;
(7-1-1) if it is a sub-member, storing the route from the regular member in array area of the memory, and advancing to the next record of the final degree;
(7-2) if it is not a sub-member, advancing to the next record of the final degree. If the record of the final degree is completed up to “n”, performing processing by progressively increasing by one the number of records of the degree one step before;
(7-3) if the number of recording of the degree one step before is completed up to “In”, performing processing by progressively increasing by one the number of records of the degree one step before;
(8) performing this procedure until the number of records of all degrees is completed;
(9) rearranging retrieval results stored in array area of the memory from the member of lower degree in the route;
(10) displaying the first of the retrieval results in the tree view area; and
(11) displaying the route selected by the user among the retrieval results in the tree view area if the user designates the change of the retrieval result display in the pulldown list box.

20. An associating information management system for associating various types of information and for managing the information, said system at least comprising:
a relationship vector table for storing relationship of said various types of information, direction of said relationship, and position time series information; and
retrieval processing means for performing retrieval processing for association based on the relationship stored in said relationship vector table, direction of said relationship and position time series information, and for performing output processing of the relationship map.

21. An associating information management system according to claim 20, wherein there is further provided a relationship management table for storing parent-child relationship between said various types of information, and said retrieval processing means outputs a relationship map to display transition of relationship along said position time series of said various types of information as said relationship map and also outputs a relationship pedigree displaying connection of said various type of information in form of chains.

22. An associating information management system according to claim 21, wherein said various types of information are under management by a member management table for storing member data consisting of identification information and detailed information.

23. An associating information management system according to claim 22, wherein said detailed information contains assortment information for assorting members.

24. An associating information management system according to claim 23, wherein said assortment information includes type, rank, classification, and job type.

25. An associating information management system according to claim 22, wherein said detailed information comprises FAT information, address recorded in FAT, file type, directory pass, file name, scope of selection, object, attribute, or information having attribute.

26. An associating information management system according to claim 22, wherein said identification information comprises ID, FAT information, address recorded in FAT, file type, directory pass, file name, scope of selection, object, attribute, or information having attribute.

27. An associating information management system according to claim 21, wherein said relationship management table comprises information of mutual associating direction and degree of relationship.

28. A program for associating information management for associating and managing various types of information by using a relationship vector table for storing relationship between said various types of information, direction of said relationship and position time series information, retrieval processing for association is performed according to the relationship, direction of the relationship and the position time series information stored in said relationship vector table, and output processing of the relationship map is carried out.

29. A recording medium for associating information management and readable by computer and for managing various types of information by association, said recording medium records a relationship vector table for storing relationship between said various types of information, said direction of relationship and said position time series information, and a retrieval processing program for performing retrieval processing of association based on the relationship, direction of the relationship and the position time series information stored in said relationship vector table and for carrying out output processing of the relationship map.
